(19) United States
(12) Patent Application Publication
(10) Pub. No.: US 2024/0285454 A1
(43) Pub. Date: Aug. 29, 2024

(54) Patient Support Apparatus With Multiple Driving Modes

(71) Applicant: Stryker Corporation, Kalamazoo, MI (US)

(72) Inventor: Anish Paul, Kalamazoo, MI (US)

(73) Assignee: Stryker Corporation, Kalamazoo, MI (US)

(21) Appl. No.: 18/571,936

(22) PCT Filed: Jun. 27, 2022
(86) PCT No.: PCT/US2022/035048

§ 371 Date: Dec. 19, 2023

Related U.S. Application Data
(60) Provisional application No. 63/244,884, filed on Sep. 16, 2021.

(51) Int. Cl. A61G 7/018

(52) U.S. Cl. CPC A61G 7/018; A61G 2203/10

(57) ABSTRACT

A patient support apparatus for transporting a patient over a floor surface is described herein. The patient support apparatus includes a drive system with a drive member, a graphical user interface for receiving user commands from a user to operate the drive system, and a control system for operating the drive system. The control system includes a memory device configured to store a plurality of drive profiles, and a controller configured to receive a first user command to select a first drive profile, select the first drive profile from the plurality of stored drive profiles, generate an output signal based on the selected drive profile, and transmit the generated output signal to the motor control circuit to operate the motor to operate the drive member in a first drive mode based on the selected drive profile.

### CROSS-REFERENCE TO RELATED APPLICATIONS

The subject patent application claims priority to, and all the benefits of, U.S. Provisional Patent Application No. 63/244,884, filed on Sep. 16, 2021, the entire contents of which are incorporated by reference herein.

### BACKGROUND

Patient support systems facilitate care of patients in a health care setting. Patient support systems may comprise patient support apparatuses such as, for example, hospital beds, stretchers, cots, wheelchairs, and transport chairs, to move patients between locations. A conventional patient support apparatus comprises a base, a patient support surface, and several support wheels, such as four swiveling caster wheels. Often, the patient support apparatus has one or more non-swiveling auxiliary wheels, in addition to the four caster wheels. The auxiliary wheel, by virtue of its non-swiveling nature, is employed to help control movement of the patient support apparatus over a floor surface in certain situations.

Those having ordinary skill in the art will appreciate that patient support apparatuses which employ powered auxiliary wheels can advantageously help caregivers propel, position, and manipulate the patient support apparatus. For example, powered auxiliary wheels can help caregivers move the patient support apparatus up or down ramps, around corners, and the like, and also may facilitate fine positioning of the patient support apparatus in rooms, elevators, and the like.

While patient support apparatuses have generally performed well for their intended use, there remains a need in the art for improved usability and adaptability to enable utilization of patient support apparatus in and between different environments and use case scenarios.

### SUMMARY

The present disclosure is directed towards a patient support apparatus with a support structure. A support wheel is coupled to the support structure. The patient support apparatus also includes a drive system with a drive member coupled to the support structure to influence motion of the patient support apparatus over a floor surface, a motor coupled to the drive member to operate the drive member at a speed, and a motor control circuit for transmitting power signals from a power source to the motor. The patient support apparatus also includes a graphical user interface for receiving user commands from a user to operate the drive system. The patient support apparatus also includes a control system coupled to the graphical user interface and the drive system for operating the drive system, the control system including: a memory device configured to store a plurality of drive profiles, and a controller coupled to the memory device and configured to: receive a first user command to select a first drive profile; select the first drive profile from the plurality of stored drive profiles; generate an output signal based on the selected drive profile; and transmit the generated output signal to the motor control circuit to operate the motor to operate the drive member in a first drive mode based on the selected drive profile.

The present disclosure is also directed towards a patient support apparatus with a support structure, a support wheel coupled to the support structure, and a drive system including a drive member coupled to the support structure to influence motion of the patient support apparatus over a floor surface, a motor coupled to the drive member to operate the drive member at a speed, and a motor control circuit for transmitting power signals from a power source to the motor. The patient support apparatus also includes a control system coupled to the drive system for operating the drive system, the control system including: a memory device configured to store a plurality of drive profiles, and a controller coupled to the memory device and configured to: detect a first drive profile based on at least one of a user input and a location associated with the patient support apparatus; select the first drive profile from the plurality of stored drive profiles; generate an output signal based on the selected drive profile; and transmit the generated output signal to the motor control circuit to operate the motor to operate the drive member in a first drive mode based on the selected drive profile.

The present disclosure is also directed towards a patient support apparatus with a support structure, a support wheel coupled to the support structure, and a drive system including a drive member coupled to the support structure to influence motion of the patient support apparatus over a floor surface, a motor coupled to the drive member to operate the drive member at a speed, and a motor control circuit for transmitting power signals from a power source to the motor. The patient support apparatus also includes a control system coupled to the drive system for operating the drive system, the control system including: a memory device configured to store a plurality of drive profiles, and a controller coupled to the memory device and configured to: detect a first location of the patient support apparatus; select a first drive profile from the plurality of stored drive profiles based on the location of the patient support apparatus; generate an output signal based on the selected drive profile; and transmit the generated output signal to the motor control circuit to operate the motor to operate the drive member in a first drive mode based on the selected drive profile.

The present disclosure is also directed towards a method of operating a drive system coupled to a patient support apparatus. The method includes receiving a first user command to select a first drive profile. The method also includes selecting the first drive profile from the plurality of stored drive profiles. The method also includes generating an output signal based on the selected drive profile. The method also includes transmitting the generated output signal to the motor control circuit to operate the motor to operate the drive member in a first drive mode based on the selected drive profile.

### BRIEF DESCRIPTION OF THE DRAWINGS

FIG. 1 is a perspective view of a patient support apparatus, according to the present disclosure.

FIG. 2 is a perspective view of an auxiliary wheel assembly of the patient support apparatus coupled to a base of the patient support apparatus shown in FIG. 1.

FIG. 3 is a perspective view of the auxiliary wheel assembly shown in FIG. 2.

FIG. 4 is an elevational view of the auxiliary wheel assembly shown in FIG. 2 in a retracted position.

FIG. 5 is an elevational view of the auxiliary wheel assembly shown in FIG. 2 in a deployed position.

FIG. 6 is a perspective view of a handle and a throttle assembly that may be used with the patient support apparatus shown in FIG. 1.

FIG. 7A is an elevational view of a first position of a throttle of the throttle assembly relative to the handle.

FIG. 7B is an elevational view of a second position of the throttle relative to the handle.

FIG. 7C is an elevational view of a third position of the throttle relative to the handle.

FIG. 7D is another elevational view of the first position of the throttle relative to the handle.

FIG. 7E is an elevational view of a fourth position of the throttle relative to the handle.

FIG. 7F is an elevational view of a fifth position of the throttle relative to the handle.

FIG. 8 is a schematic view of a control system of the patient support apparatus shown in FIG. 1.

FIG. 9 is a schematic wire diagram of an auxiliary wheel assembly control circuit that may be used with the auxiliary wheel assembly shown in FIG. 1.

FIG. 10 is a schematic wire diagram of a motor control circuit that may be used with the auxiliary wheel assembly shown in FIG. 1.

FIG. 11 is a flowchart illustrating an illustrative algorithms that may be executed by the control system of the patient support apparatus for operating the auxiliary wheel assembly, according to versions of the present disclosure.

FIGS. 12-14 illustrate data files that may be used with the algorithm illustrated that may be executed by the control system of the patient support apparatus shown in FIG. 11, according to versions of the present disclosure.

FIG. 15 illustrates a graphical user interface that may receive user commands from a user to operate the auxiliary wheel assembly.

FIG. 16 illustrates a graphical user interface that may receive user commands from a user to operate the auxiliary wheel assembly in a first drive mode based on a drive profile.

FIGS. 16A-16B illustrate data files that may be used with an algorithm illustrated that may be executed by the control system of the patient support apparatus shown in FIG. 11 according to the drive mode shown in FIG. 16.

FIG. 17 illustrates a graphical user interface that may receive user commands from a user to operate the auxiliary wheel assembly in a second drive mode based on a drive profile.

FIGS. 17A-17B illustrate data files that may be used with an algorithm illustrated that may be executed by the control system of the patient support apparatus shown in FIG. 11 according to the drive mode shown in FIG. 17.

### DETAILED DESCRIPTION

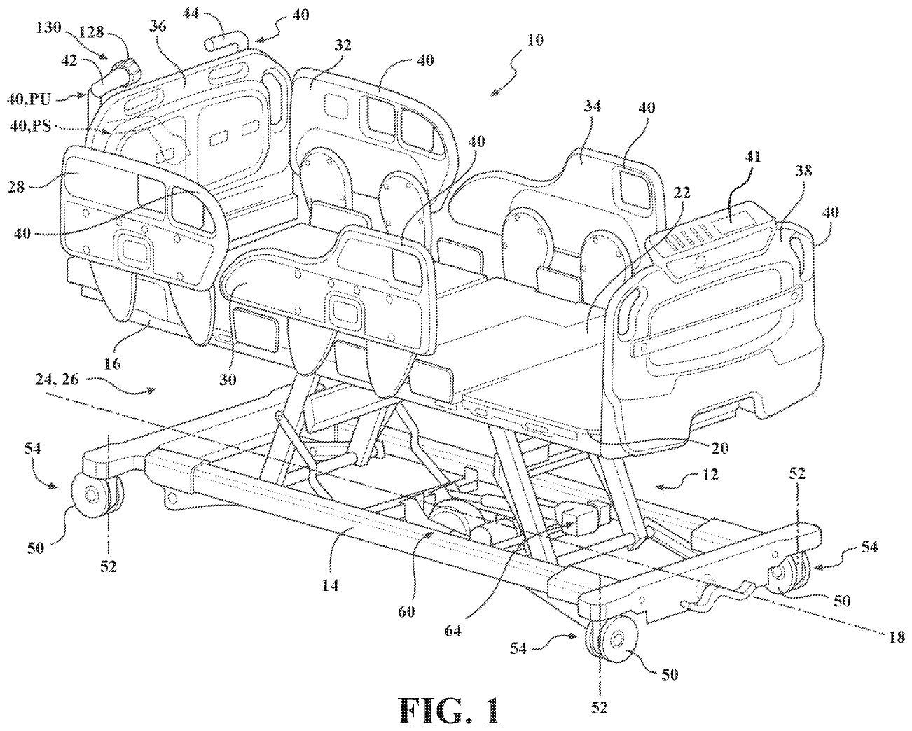

Referring to FIG. 1, a patient transport system comprising a patient support apparatus 10 is shown for supporting a patient in a health care setting. The patient support apparatus 10 illustrated in FIG. 1 comprises a hospital bed. In some versions, however, the patient support apparatus 10 may comprise a stretcher, a cot, a wheelchair, and a transport chair, or similar apparatus, utilized in the care of a patient to transport the patient between locations.

A support structure 12 provides support for the patient. The support structure 12 illustrated in FIG. 1 comprises a base 14 and an intermediate frame 16. The base 14 defines a longitudinal axis 18 from a head end to a foot end. The intermediate frame 16 is spaced above the base 14. The support structure 12 also comprises a patient support deck 20 disposed on the intermediate frame 16. The patient support deck 20 comprises several sections, some of which articulate (e.g., pivot) relative to the intermediate frame 16, such as a fowler section, a seat section, a thigh section, and a foot section. The patient support deck 20 provides a patient support surface 22 upon which the patient is supported.

In certain versions, such as is depicted in FIG. 1, the patient support apparatus 10 further comprises a lift assembly, generally indicated at 24, which operates to lift and lower the intermediate frame 16 relative to the base 14. The lift assembly 24 is configured to move the intermediate frame 16 between a plurality of vertical configurations relative to the base 14 (e.g., between a minimum height and a maximum height, or to any desired position in between). To this end, the lift assembly 24 comprises one or more bed lift actuators 26 which are arranged to facilitate movement of the intermediate frame 16 with respect to the base 14. The bed lift actuators 26 may be realized as linear actuators, rotary actuators, or other types of actuators, and may be electrically operated, hydraulic, electro-hydraulic, or the like. It is contemplated that, in some versions, separate lift actuators could be disposed to facilitate independently lifting the head and foot ends of the intermediate frame 16 and, in some versions, only one lift actuator may be employed, (e.g., to raise only one end of the intermediate frame 16). The construction of the lift assembly 24 and/or the bed lift actuators 26 may take on any known or conventional design, and is not limited to that specifically illustrated. One exemplary lift assembly that can be utilized on the patient support apparatus 10 is described in U.S. Patent Application Publication No. 2016/0302985, entitled “Patient Support Lift Assembly”, which is hereby incorporated herein by reference in its entirety.

A mattress, although not shown, may be disposed on the patient support deck 20. The mattress comprises a secondary patient support surface upon which the patient is supported. The base 14, intermediate frame 16, patient support deck 20, and patient support surface 22 each have a head end and a foot end corresponding to designated placement of the patient's head and feet on the patient support apparatus 10. The construction of the support structure 12 may take on any known or conventional design, and is not limited to that specifically set forth above. In addition, the mattress may be omitted in certain versions, such that the patient rests directly on the patient support surface 22.

Side rails 28, 30, 32, 34 are supported by the base 14. A first side rail 28 is positioned at a right head end of the intermediate frame 16. A second side rail 30 is positioned at a right foot end of the intermediate frame 16. A third side rail 32 is positioned at a left head end of the intermediate frame 16. A fourth side rail 34 is positioned at a left foot end of the intermediate frame 16. If the patient support apparatus 10 is a stretcher, there may be fewer side rails. The side rails 28, 30, 32, 34 are movable between a raised position in which they block ingress and egress into and out of the patient support apparatus 10 and a lowered position in which they are not an obstacle to such ingress and egress. The side rails 28, 30, 32, 34 may also be movable to one or more intermediate positions between the raised position and the lowered position. In still other configurations, the patient support apparatus 10 may not comprise any side rails.

A headboard 36 and a footboard 38 are coupled to the intermediate frame 16. In some versions, when the headboard 36 and footboard 38 are provided, the headboard 36 and footboard 38 may be coupled to other locations on the patient support apparatus 10, such as the base 14. In still other versions, the patient support apparatus 10 does not comprise the headboard 36 and/or the footboard 38.

User interfaces 40, such as handles, are shown integrated into the footboard 38 and side rails 28, 30, 32, 34 to facilitate movement of the patient support apparatus 10 over floor surfaces. The user interfaces 40 are graspable by the user to manipulate the patient support apparatus 10 for movement.

Other forms of the user interface 40 are also contemplated. The user interface may simply be a surface on the patient support apparatus 10 upon which the user logically applies force to cause movement of the patient support apparatus 10 in one or more directions, also referred to as a push location. This may comprise one or more surfaces on the intermediate frame 16 or base 14. This could also comprise one or more surfaces on or adjacent to the headboard 36, footboard 38, and/or side rails 28, 30, 32, 34.

Additional user interfaces 40 may be integrated into the headboard 36, footboard 38, and/or other components of the patient support apparatus 10. Such additional user interfaces 40 may include, for example, a graphical user interface 41. The graphical user interface 41 may be configured to receive user commands from a user to operate an auxiliary wheel assembly 60 of a drive system 78 configured to influence motion of the patient support apparatus 10.

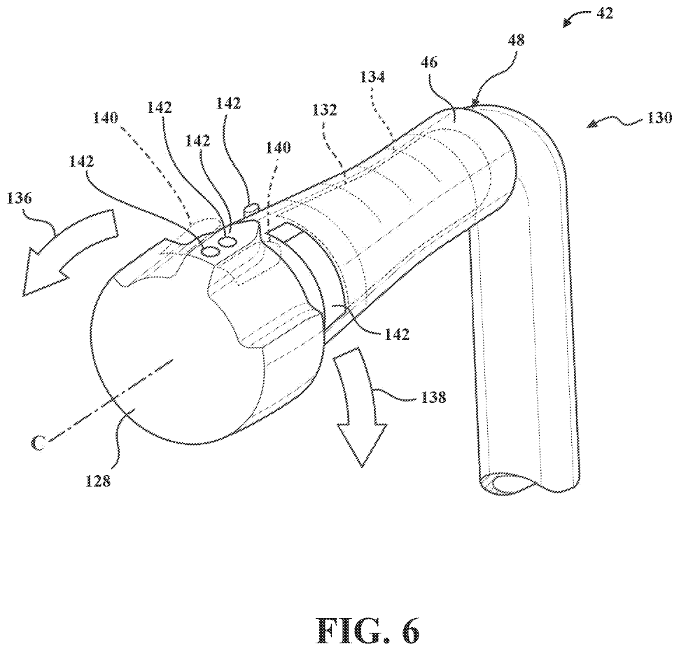

In the version shown in FIG. 1, one set of user interfaces 40 comprises a first handle 42 and a second handle 44. The first and second handles 42, 44 are coupled to the intermediate frame 16 proximal to the head end of the intermediate frame 16 and on opposite sides of the intermediate frame 16 so that the user may grasp the first handle 42 with one hand and the second handle 44 with the other. As is described in greater detail below in connection with FIGS. 1 and 6, in some versions the first handle 42 comprises an inner support 46 defining a central axis C, and handle body 48 configured to be gripped by the user. In some versions, the first and second handles 42, 44 are coupled to the headboard 36. In still other versions the first and second handles 42, 44 are coupled to another location permitting the user to grasp the first and second handle 42, 44. As shown in FIG. 1, one or more of the user interfaces (e.g., the first and second handles 42, 44) may be arranged for movement relative to the intermediate frame 16, or another part of the patient support apparatus 10, between a use position PU arranged for engagement by the user, and a stow position PS (depicted in phantom), with movement between the use position PU and the stow position PS being facilitated such as by a hinged or pivoting connection to the intermediate frame 16 (not shown in detail). Other configurations are contemplated.

Support wheels 50 are coupled to the base 14 to support the base 14 on a floor surface such as a hospital floor. The support wheels 50 allow the patient support apparatus 10 to move in any direction along the floor surface by swiveling to assume a trailing orientation relative to a desired direction of movement. In the version shown, the support wheels 50 comprise four support wheels each arranged in corners of the base 14. The support wheels 50 shown are caster wheels able to rotate and swivel about swivel axes 52 during transport. Each of the support wheels 50 forms part of a caster assembly 54. Each caster assembly 54 is mounted to the base 14. It should be understood that various configurations of the caster assemblies 54 are contemplated. In addition, in some versions, the support wheels 50 are not caster wheels and may be non-steerable, steerable, non-powered, powered, or combinations thereof. Additional support wheels 50 are also contemplated.

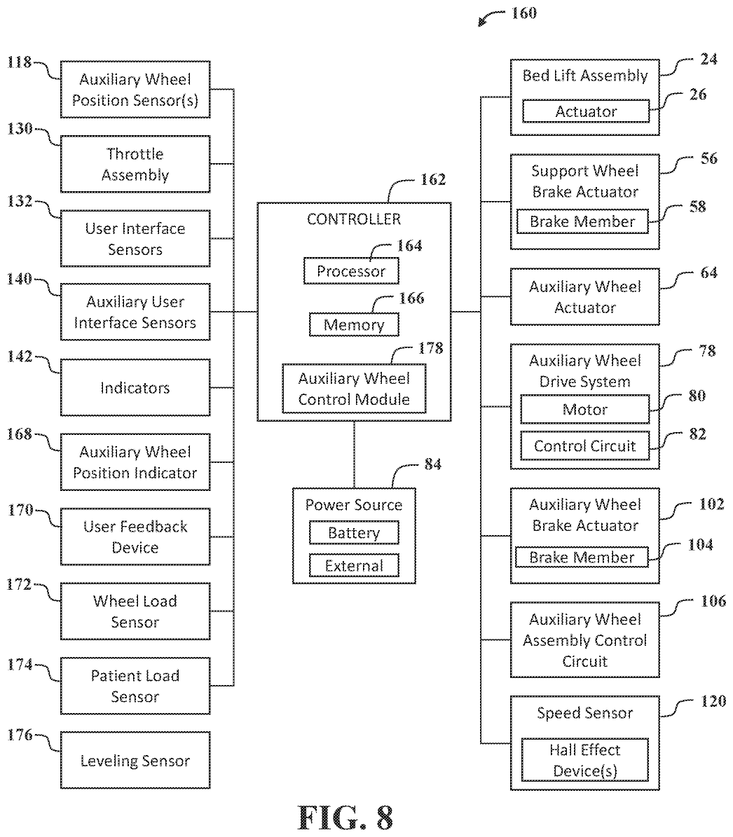

In some versions, the patient support apparatus 10 comprises a support wheel brake actuator 56 (shown schematically in FIG. 8) operably coupled to one or more of the support wheels 50 for braking one or more support wheels 50. In some versions, the support wheel brake actuator 56 may comprise a brake member 58 coupled to the base 14 and movable between a braked position engaging one or more of the support wheels 50 to brake the support wheel 50 and a released position permitting one or more of the support wheels 50 to rotate freely.

Referring to FIGS. 1-3, the auxiliary wheel assembly 60 is coupled to the base 14. The auxiliary wheel assembly 60 forms part of the drive system 78 in the illustrated versions. As noted above, the drive system 78 is configured to influence motion of the patient support apparatus 10 during transportation over the floor surface. To this end, the drive system 78 generally includes a drive member 62 and a motor 80 coupled to the drive member 62 to operate the drive member 62 at various speeds. In the illustrated versions, the drive member 62 is realized as an auxiliary wheel 62 forming part of the auxiliary wheel assembly 60 of an auxiliary wheel drive system 78 as described in greater detail below. However, those having ordinary skill in the art will appreciate that the drive system 78 could be configured in other ways, with various types of drive members 62 other than those configured as auxiliary wheels 62 of auxiliary wheel assemblies 60. By way of non-limiting example, the drive member 62 could be realized by various types and/or arrangements of one or more belts, treads, wheels, tires, and the like, which may be arranged in various ways about the patient support apparatus 10 and may be deployable, retractable, or similarly movable, or may be generally engaged with the floor surface (e.g., realized as powered wheels at one or more corners of the base 14). Other configurations are contemplated. Accordingly, it will be appreciated that the auxiliary wheel drive system 78 described and illustrated herein represents one type of drive system 78 contemplated by the present disclosure, and the auxiliary wheel 62 described and illustrated herein represents one type of drive member 62 contemplated by the present disclosure.

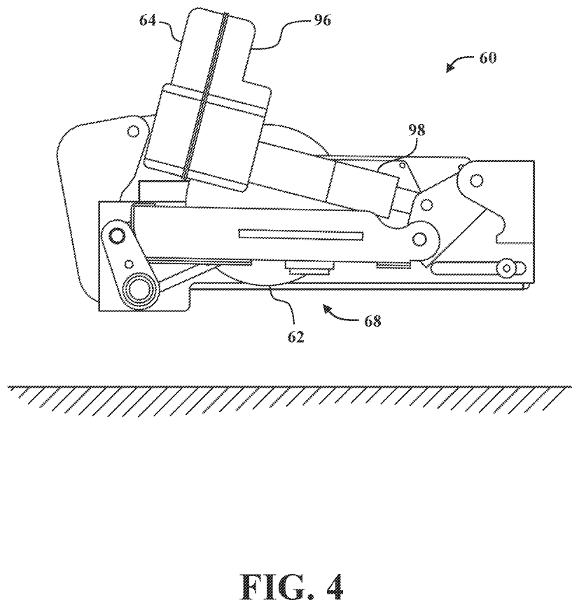

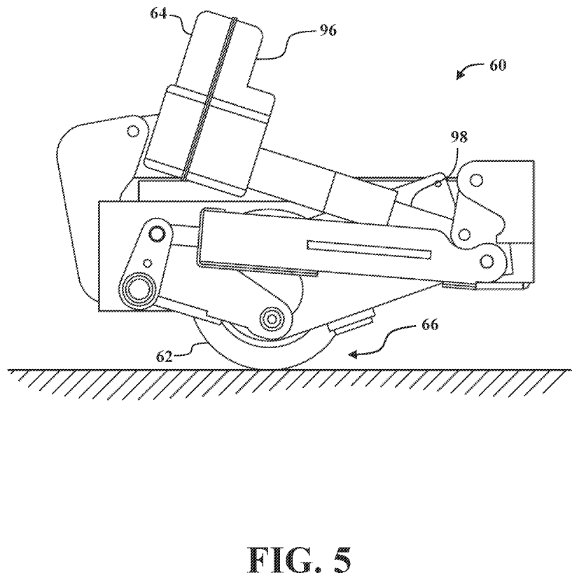

With continued reference to FIGS. 1-3, the illustrated auxiliary wheel assembly 60 employs an auxiliary wheel actuator 64 operatively coupled to the auxiliary wheel 62 and operable to move the auxiliary wheel 62 between a deployed position 66 (see FIG. 5) engaging the floor surface, and a retracted position 68 (see FIG. 4) spaced away from and out of contact with the floor surface. The retracted position 68 may alternatively be referred to as the “fully retracted position.” The auxiliary wheel 62 may also be positioned in one or more intermediate positions between the deployed position 66 (see FIG. 5) and the retracted position 68 (FIG. 4). The intermediate positions may alternatively be referred to as a “partially retracted position,” or may also refer to another “retracted position” (e.g., compared to the “fully” retracted position 68 depicted in FIG. 4). The auxiliary wheel 62 influences motion of the patient support apparatus 10 during transportation over the floor surface when the auxiliary wheel 62 is in the deployed position 66. In some versions, the auxiliary wheel assembly 60 comprises an additional auxiliary wheel movable with the auxiliary wheel 62 between the deployed position 66 and the retracted position 68 via the auxiliary wheel actuator 64.

By deploying the auxiliary wheel 62 on the floor surface, the patient support apparatus 10 can be easily moved down long, straight hallways or around corners, owing to a non-swiveling nature of the auxiliary wheel 62. When the auxiliary wheel 62 is in the retracted position 68 (see FIG. 4) or in one of the intermediate positions (e.g. spaced from the floor surface), the patient support apparatus 10 may be subject to moving in an undesired direction due to uncontrollable swiveling of the support wheels 50. For instance, during movement down long, straight hallways, the patient support apparatus 10 may be susceptible to “dog tracking,” which refers to undesirable sideways movement of the patient support apparatus 10. Additionally, when cornering, without the auxiliary wheel 62 deployed, and with all of the support wheels 50 able to swivel, there is no wheel assisting with steering through the corner, unless one or more of the support wheels 50 are provided with steer lock capability and the steer lock is activated.

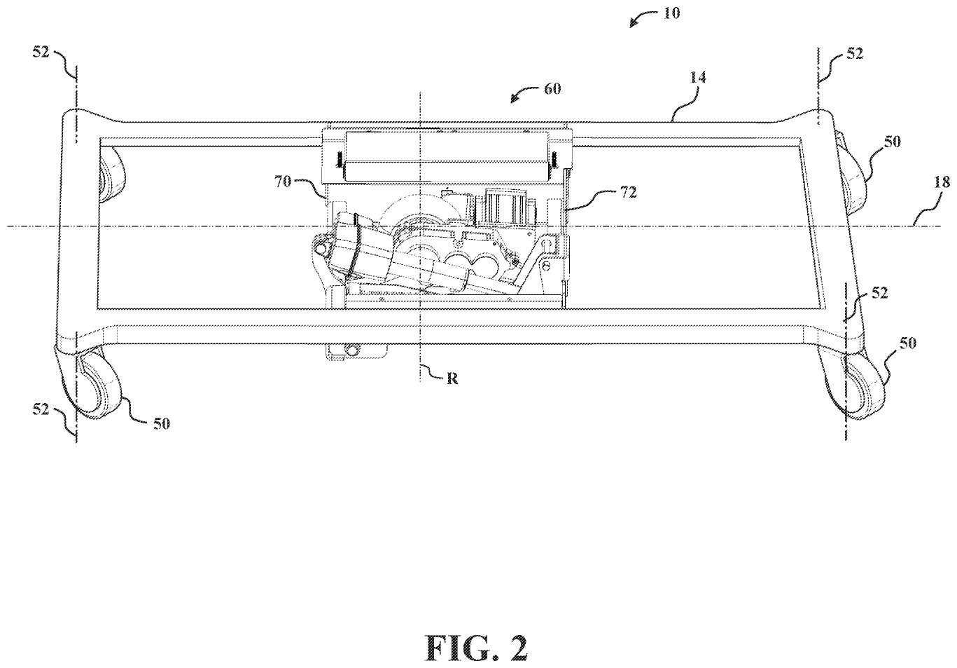

The auxiliary wheel 62 may be arranged parallel to the longitudinal axis 18 of the base 14. The differently, the auxiliary wheel 62 rotates about a rotational axis R (see FIG. 2) oriented perpendicularly to the longitudinal axis 18 of the base 14 (albeit offset in some cases from the longitudinal axis 18). In the version shown, the auxiliary wheel 62 is incapable of swiveling about a swivel axis. In some versions, the auxiliary wheel 62 may be capable of swiveling, but can be locked in a steer lock position in which the auxiliary wheel 62 is locked to solely rotate about the rotational axis R oriented perpendicularly to the longitudinal axis 18. In still other versions, the auxiliary wheel 62 may be able to freely swivel without any steer lock functionality or may be steered.

The auxiliary wheel 62 may be located to be deployed inside a perimeter of the base 14 and/or within a support wheel perimeter defined by the swivel axes 52 of the support wheels 50. In some versions, such as those employing a single auxiliary wheel 62, the auxiliary wheel 62 may be located near a center of the support wheel perimeter, or offset from the center. In this case, the auxiliary wheel 62 may also be referred to as a fifth wheel. In some versions, the auxiliary wheel 62 may be disposed along the support wheel perimeter or outside of the support wheel perimeter. In the version shown, the auxiliary wheel 62 has a diameter larger than a diameter of the support wheels 50. In some versions, the auxiliary wheel 62 may have the same or a smaller diameter than the support wheels 50.

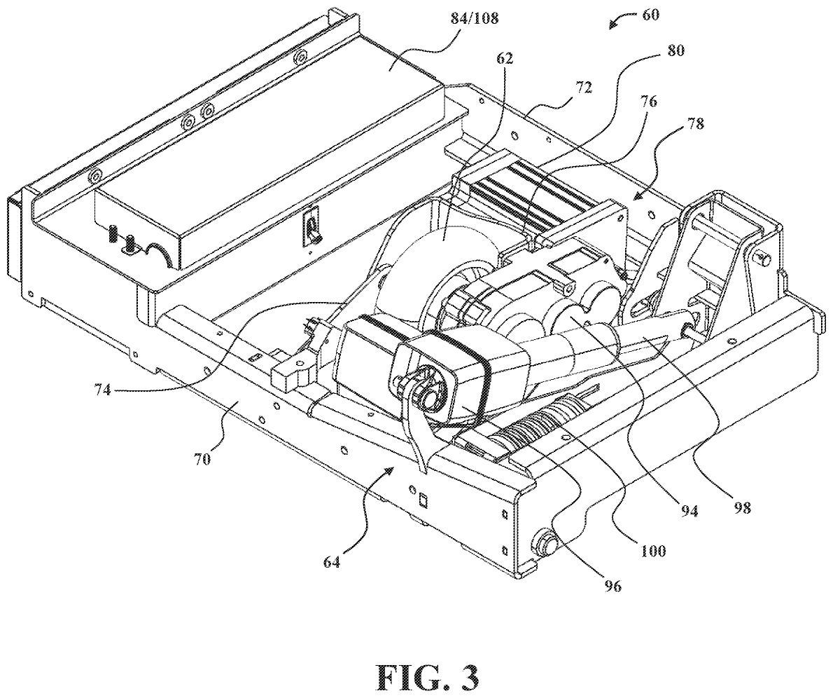

In the version shown in FIG. 3, the base 14 comprises a first cross-member 70 and a second cross-member 72. The auxiliary wheel assembly 60 is disposed between and coupled to the cross-members 70, 72. The auxiliary wheel assembly 60 comprises a first auxiliary wheel frame 74 coupled to and arranged to articulate (e.g. pivot) relative to the first cross-member 70. The auxiliary wheel assembly 60 further comprises a second auxiliary wheel frame 76 pivotably coupled to the first auxiliary wheel frame 74 and the second cross-member 72. The second auxiliary wheel frame 76 is arranged to articulate and translate relative to the second cross-member 72.

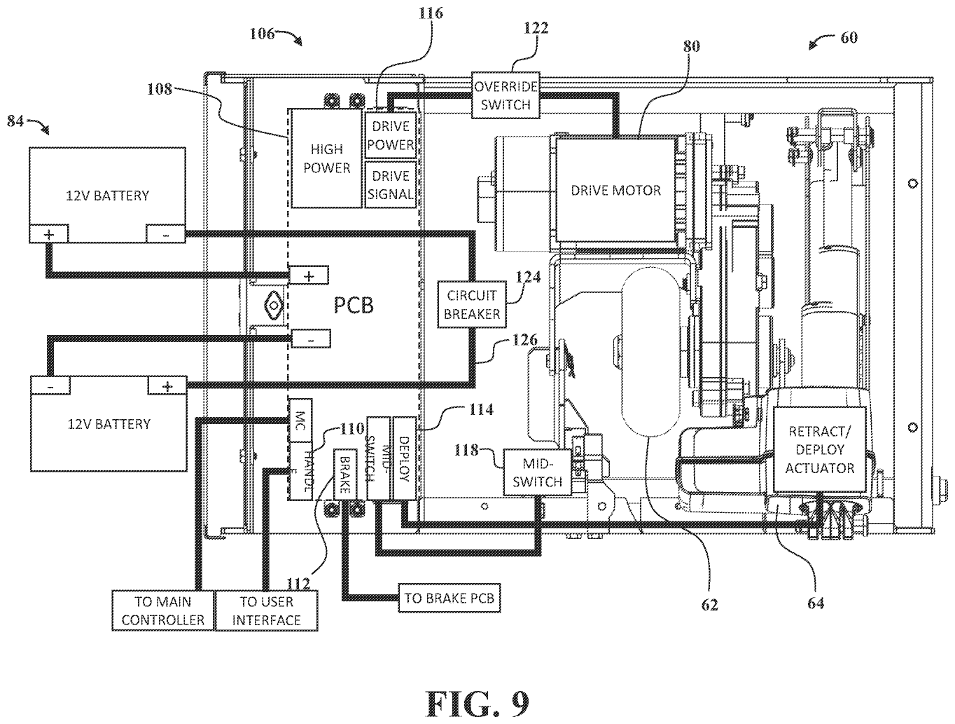

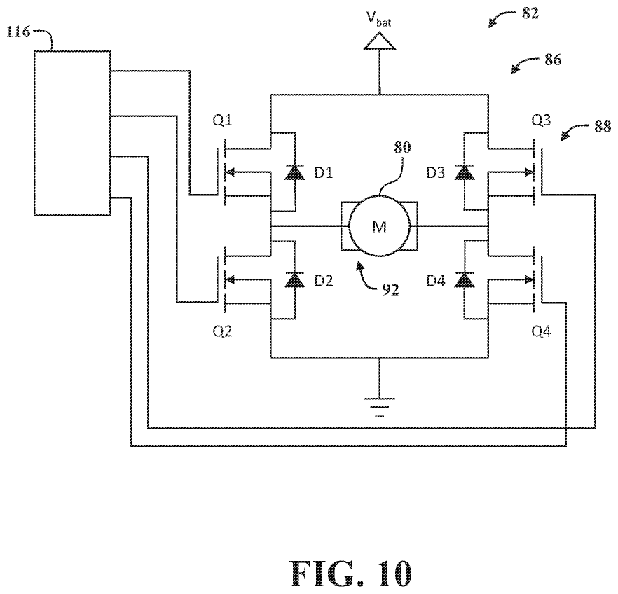

In the version shown in FIGS. 2-3, the auxiliary wheel assembly 60 comprises an auxiliary wheel drive system 78 (described in more detail below) operatively coupled to the auxiliary wheel 62. The auxiliary wheel drive system 78 is configured to drive (e.g. rotate) the auxiliary wheel 62. In the version shown, the auxiliary wheel drive system 78 comprises the motor 80 coupled to the auxiliary wheel 62 for rotating the auxiliary wheel 62 relative to the support structure and a motor control circuit 82 (shown in FIGS. 9 and 10) that is configured to transmit control and power signals to the motor 80. The motor control circuit 82 is also coupled to a power source 84 (shown schematically in FIG. 9) for use in generating the control and power signals that are used to operate the motor 80. In the version shown, the motor control circuit 82 includes a motor bridge circuit 86 that includes a plurality of field-effect transistor (FET) switches 88 (e.g. Q1, Q2, Q3, Q4 shown in FIG. 10) that are coupled to motor leads 92 of the motor 80. In some versions, the motor 80 includes a 3-phase BLDC motor. In some versions, any suitable motor may be used with auxiliary wheel drive system 78.

The auxiliary wheel drive system 78 also includes a gear train 94 that is coupled to the motor 80 and an axle of the auxiliary wheel 62. In the version shown, the auxiliary wheel 62, the gear train 94, and the motor 80 are arranged and supported by the second auxiliary wheel frame 76 to articulate and translate with the second auxiliary wheel frame 76 relative to the second cross-member 72. In some versions, the axle of the auxiliary wheel 62 is coupled directly to the second auxiliary wheel frame 76 and the auxiliary wheel drive system 78 drives the auxiliary wheel 62 in another manner. Electrical power is provided from the power source 84 to energize the motor 80. The motor 80 converts electrical power from the power source 84 to torque supplied to the gear train 94. The gear train 94 transfers torque to the auxiliary wheel 62 to rotate the auxiliary wheel 62.

In the version shown, the auxiliary wheel actuator 64 is a linear actuator comprising a housing 96 and a drive rod 98 extending from the housing 96. The drive rod 98 has a proximal end received in the housing 96 and a distal end spaced from the housing 96. The distal end of the drive rod 98 is configured to be movable relative to the housing 96 to extend and retract an overall length of the auxiliary wheel actuator 64. In the version shown, the auxiliary wheel assembly 60 also comprises a biasing device such as a spring cartridge 100 to apply a biasing force. Operation of the auxiliary wheel actuator 64 and the spring cartridge 100 to retract/deploy the auxiliary wheel 62 is described in U.S. patent application Ser. No. 16/690,217, filed on Nov. 21, 2019, entitled, “Patient Transport Apparatus With Controlled Auxiliary Wheel Deployment,” which is hereby incorporated herein by reference.

Referring to FIGS. 4 and 5, when moving to the retracted position 68, auxiliary wheel actuator 64 retracts the drive rod 98 into the housing 96 to move the auxiliary wheel 62 from the deployed position 66 to the retracted position 68. When moving to the deployed position 66, auxiliary wheel actuator 64 extends the drive rod 98 from the housing 96 to move the auxiliary wheel 62 from the retracted position 68 to the deployed position 66. Various linkages are contemplated for such movement, including those disclosed in U.S. patent application Ser. No. 16/690,217, filed on Nov. 21, 2019, entitled, “Patient Transport Apparatus With Controlled Auxiliary Wheel Deployment,” which is incorporated herein by reference. In some versions, the housing 96 of the auxiliary wheel actuator 64 may be fixed to the cross member 70 and directly connected to the auxiliary wheel 62 to directly retract/deploy the auxiliary wheel 62. Other configurations are also contemplated.

In some versions, the auxiliary wheel assembly 60 comprises an auxiliary wheel brake actuator 102 (shown schematically in FIG. 8) operably coupled to the auxiliary wheel 62 for braking the auxiliary wheel 62. The auxiliary wheel brake actuator 102 may comprise a brake member 104 coupled to the base 14 and movable between a braked position engaging the auxiliary wheel 62 to brake the auxiliary wheel 62 and a released position permitting the auxiliary wheel 62 to rotate.

In the version shown, the auxiliary wheel assembly 60 includes an auxiliary wheel assembly control circuit 106 (see FIGS. 9 and 10) that is coupled to the auxiliary wheel actuator 64, the auxiliary wheel drive system 78, the auxiliary wheel brake actuator 102, and a power supply 84 for controlling operation of the auxiliary wheel assembly 60. In some versions, the power supply 84 may include a pair of rechargeable 12-volt batteries for providing electrical power to the auxiliary wheel assembly 60. In some versions, the power supply 84 may include one or more batteries that may be rechargeable and/or non-rechargeable and may be rated for use at voltages other than 12-volts. In some versions, as shown in FIG. 9, the auxiliary wheel assembly control circuit 106 includes a printed circuit board 108 mounted to the base 14 and having a user interface control unit 110, a brake control unit 112, an auxiliary wheel actuator control unit 114, and an auxiliary wheel control unit 116 mounted thereon. The auxiliary wheel assembly control circuit 106 may also include one or more auxiliary wheel position sensors 118, one or more auxiliary wheel speed sensors 120 (shown in FIG. 8), an override switch 122 operable to disconnect power to the motor 80, and a circuit breaker 124 coupled to the power supply 84.

In some versions, the auxiliary wheel assembly control circuit 106 includes an electrical current sense circuit 126 that is configured to sense the electrical current drawn by the motor 80 from the power supply 84. The electrical current sense circuit 126 may also be configured to sense an electrical current through motor phase windings of the motor 80. In addition, the electrical current sense circuit 126 may be configured to sense the electrical current drawn by the auxiliary wheel brake actuator 102.

The user interface control unit 110 is configured to transmit and receive instructions from the user interface 40 to enable a user to operate the auxiliary wheel assembly 60 with the user interface 40. The auxiliary wheel control unit 116 is configured to control the operation of the auxiliary wheel drive system 78 based on signals received from the user interface 40 via the user interface control unit 110. The brake control unit 112 is configured to operate the auxiliary wheel brake actuator 102 for braking the auxiliary wheel 62, or may control another electronic braking system on the patient support apparatus 10, such as one for the support wheels 50. The auxiliary wheel actuator control unit 114 is configured to operate the auxiliary wheel actuator 64 to move the auxiliary wheel 62 between the deployed and retracted positions. The auxiliary wheel position sensor 118 is configured to sense a position of the auxiliary wheel actuator 64. In some versions, the auxiliary wheel position sensor 118 may include a mid-switch that is configured to detect a position of the auxiliary wheel 62 in the deployed position 66, the retracted position 68, and any intermediate position between the deployed position 66 and the retracted position 68. In some versions, the auxiliary wheel position switch 118 may be configured to read off a cam surface (not shown) and indicates when the auxiliary wheel 62 is in a specific position between fully deployed and fully retracted. In some versions, two or more limit switches, optical sensors, hall-effect sensors, or other types of sensors may be used to detect the current position of the auxiliary wheel 62.

The auxiliary wheel speed sensor 120 is configured to sense a rotational speed of the auxiliary wheel. In some versions, the auxiliary wheel speed sensor 120 may include one or more hall effect devices that are configured to sense rotation of the motor 80 (e.g., the motor shaft). The auxiliary wheel speed sensor 120 may also be used to detect a rotation of the auxiliary wheel 62 for use in determining whether the auxiliary wheel 62 is in a stop position and is not rotating. The auxiliary wheel speed sensor 120 may also be any other suitable sensor for measuring wheel speed, such as an optical encoder.

The override switch 122 is configured to disconnect power to the drive motor 80 to enable the auxiliary wheel 62 to rotate more freely. It should be appreciated that in some versions, such as that shown in FIG. 9, when power to the drive motor 80 is disconnected, frictional forces may still be present between the drive motor 80 and auxiliary wheel 62 by virtue of the gear train 94 such that rotation of the auxiliary wheel 62 is at least partially inhibited by the gear train 94. Depending on the nature of the gear train 94, the torque required to overcome such frictional forces vary. In some versions, the gear train 94 may be selected to minimize the torque required to manually drive the auxiliary wheel 62. In some versions, a clutch may be employed between the auxiliary wheel 62 and the gear train 94 that is operated to disconnect the gear train 94 from the auxiliary wheel 62 when the override switch 122 is activated. In some versions, the drive motor 80 may directly drive the auxiliary wheel 62 (e.g., without a gear train), in which case, the auxiliary wheel 62 may rotate freely when power to the drive motor 80 is disconnected. If the auxiliary wheel 62 remains stuck in the deployed position or an intermediate position, the auxiliary wheel assembly control circuit 106 may operate the override switch 122 to disconnect power to the drive motor 80 and allow the auxiliary wheel 62 to rotate more freely. The circuit breaker 124 is configured to trip if an accidental electrical current spike is detected. In addition, the circuit breaker 124 may be switched to an “off” position to disconnect the power supply 84 to save battery life for storage and shipping.

Although exemplary versions of an auxiliary wheel assembly 60 is described above and shown in the drawings, it should be appreciated that other configurations employing an auxiliary wheel actuator 64 to move the auxiliary wheel 62 between the retracted position 68 and deployed position 66 are contemplated.

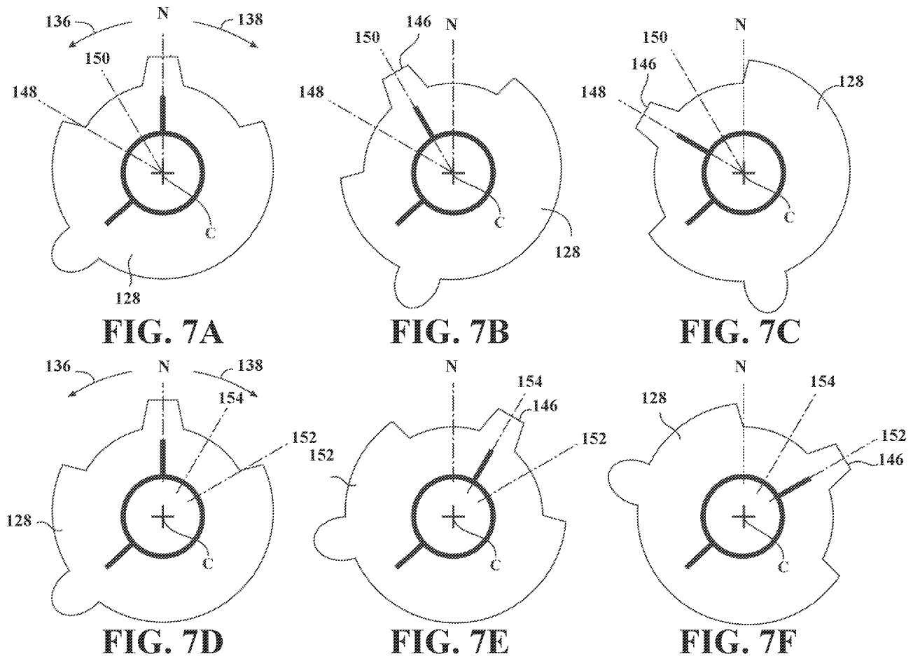

In the version shown in FIG. 6, the auxiliary wheel drive system 78 is configured to drive (e.g. rotate) the auxiliary wheel 62 in response to a throttle 128 operable by the user. As is described in greater detail below in connection with FIGS. 6-7F, the throttle 128 is operatively attached to the first handle 42 in the illustrated version to define a throttle assembly 130.

In some versions, such as those shown in FIGS. 6-7F, one or more user interface sensors 132 (e.g., capacitive sensors or the like) are coupled to the first handle 42 to determine engagement by the user and generate a signal responsive to touch (e.g. hand placement/contact) of the user. The one or more user interface sensors 132 are operatively coupled to the auxiliary wheel actuator 64 to control movement of the auxiliary wheel 62 between the deployed position 66 and the retracted position 68. Operation of the auxiliary wheel actuator 64 in response to the user interface sensor 132 is described in more detail below. In some versions, the user interface sensor 132 is coupled to another portion of the patient support apparatus 10, such as another user interface 40.

In some versions, such as is depicted in FIG. 6, engagement features or indicia 134 are located on the first handle 42 to indicate to the user where the user's hands may be placed on a particular portion of the first handle 42 for the user interface sensor 132 to generate the signal indicating engagement by the user. For instance, the first handle 42 may comprise embossed or indented features to indicate where the user's hand should be placed. In some versions, the indicia 134 comprises a film, cover, or ink disposed at least partially over the first handle 42 and shaped like a handprint to suggest the user's hand should match up with the handprint for the user interface sensor 132 to generate the signal. In still other versions, the shape of the user interface sensor 132 acts as the indicia 134 to indicate where the user's hand should be placed for the user interface sensor 132 to generate the signal. In some versions (not shown), the patient support apparatus 10 does not comprise a user interface sensor 132 operatively coupled to the auxiliary wheel actuator 64 for moving the auxiliary wheel 62 between the deployed position 66 and the retracted position 68. Instead, a user input device is operatively coupled to the auxiliary wheel actuator 64 for the user to selectively move the auxiliary wheel 62 between the deployed position 66 and the retracted position 68. In some versions, both the user interface sensor 132 and the user input device are employed.

Referring now to FIGS. 7A-7F, the throttle 128 is illustrated in various positions. In FIGS. 7A and 7D, the throttle is in a neutral throttle position N. The throttle 128 is movable in a first direction 136 (also referred to as a “forward direction”) relative to the neutral throttle position N and a second direction 138 (also referred to as a “backward direction”) relative to the neutral throttle position N opposite the first direction 136. As will be appreciated from the subsequent description below, the auxiliary wheel drive system 78 drives the auxiliary wheel 62 in a forward direction when the throttle 128 is moved in the first direction 136, and in a rearward direction opposite the forward direction when the throttle 128 is moved in the second direction 138. When the throttle 128 is disposed in the neutral throttle position N, as shown in FIG. 7A (see also FIG. 7D), the auxiliary wheel drive system 78 does not drive the auxiliary wheel 62 in either direction. In many versions, the throttle 128 is spring-biased to the neutral throttle position N.

As is described in greater detail below, when the throttle 128 is in the neutral throttle position N, the auxiliary wheel drive system 78 may permit the auxiliary wheel 62 to be manually rotated as a result of a user pushing on the first handle 42 or another user interface 40 to push the patient support apparatus 10 in a desired direction. In other words, the motor 80 may be unbraked and capable of being driven manually.

It should be appreciated that the terms forward and backward are used to describe opposite directions that the auxiliary wheel 62 rotates to move the base 14 along the floor surface. For instance, forward refers to movement of the patient support apparatus 10 with the foot end leading and backward refers to the head end leading. In some versions, backward rotation moves the patient support apparatus 10 in the direction with the foot end leading and forward rotation moves the patient support apparatus 10 in the direction with the head end leading. In such versions, the handles 42, 44 may be located at the foot end.

Referring to FIG. 6, the location of the throttle 128 relative to the first handle 42 permits the user to simultaneously grasp the handle body 48 of the first handle 42 and rotate the throttle 128 about the central axis C defined by the inner support 46. This allows the user interface sensor 132, which is operatively attached to the handle body 48 in the illustrated version, to generate the signal responsive to touch by the user while the user moves the throttle 128. In some versions, the throttle 128 comprises one or more throttle interfaces (e.g., ridges, raised surfaces, grip portions, etc.) for assisting the user with rotating the throttle 128.

In some versions, the throttle assembly 130 may comprise one or more auxiliary user interface sensors 140 (shown in phantom), in addition to the user interface sensor 132, to determine engagement by the user. In the version illustrated in FIG. 6, the auxiliary user interface sensors 140 are realized as throttle interface sensors respectively coupled to each of the throttle interfaces and operatively coupled to the auxiliary wheel drive system 78 (e.g., via electrical communication). The throttle interface sensors are likewise configured to determine engagement by the user and generate a signal responsive to touch of the user's thumb and/or fingers. When the user is touching one or more of the throttle interfaces, the throttle interface sensors generate a signal indicating the user is currently touching one or more of the throttle interfaces and movement of the throttle 128 is permitted to cause rotation of the auxiliary wheel 62. When the user is not touching any of the throttle interfaces, the throttle interface sensors generate a signal indicating an absence of the user's thumb and/or fingers on the throttle interfaces and movement of the throttle 128 is restricted from causing rotation of the auxiliary wheel 62. The throttle interface sensors mitigate the chances for inadvertent contact with the throttle 128 to unintentionally cause rotation of the auxiliary wheel 62. The throttle interface sensors may be absent in some versions. As is described in greater detail below in connection with FIG. 6, other types of auxiliary user interface sensors 140 are contemplated by the present disclosure besides the throttle interface sensors described above. Furthermore, it will be appreciated that certain versions may comprise both the user interface sensor 132 and the auxiliary user interface sensor 140 (e.g., one or more throttle interface sensors), whereas some versions may comprise only one of either the user interface sensor 132 and the auxiliary user interface sensor 140. Various visual indicators 142 (e.g., LEDs, displays, illuminated surfaces, etc.) may also be present on the throttle 128 or the handle body 48 to indicate a current operational mode, speed, state (deployed/retracted), condition, etc. of the auxiliary wheel assembly 60. Other configurations are contemplated.

Referring again to FIGS. 7A-7F, various positions of the throttle 128 are shown. The throttle 128 is movable relative to the first handle 42 to a first throttle position, a second throttle position, and intermediate throttle positions therebetween. The throttle 128 is operable between the first throttle position and the second throttle position to adjust the rotational speed of the auxiliary wheel.

In some versions, the first throttle position corresponds with the neutral throttle position N (shown in FIGS. 7A and 7D) and the auxiliary wheel 62 is at rest. The second throttle position corresponds with a maximum forward throttle position 148 (shown in FIG. 7C) of the throttle 128 moved in the first direction 136. One intermediate throttle position corresponds with an intermediate forward throttle position 150 (shown FIG. 7B) of the throttle 128 between the neutral throttle position N and the maximum forward throttle position 148. Here, both the maximum forward throttle position 148 and the intermediate forward throttle position 150 may also be referred to as forward throttle positions.

In other cases, the second throttle position corresponds with a maximum backward throttle position 152 (shown in FIG. 7F) of the throttle 128 moved in the second direction 138. Here, one intermediate throttle position corresponds with an intermediate backward throttle position 154 (shown in FIG. 7E) of the throttle 128 between the neutral throttle position N and the maximum backward throttle position 152. Here, both the maximum backward throttle position 152 and the intermediate backward throttle position 154 may also be referred to as backward throttle positions.

In the versions shown, the throttle 128 is movable from the neutral throttle position N to one or more operating throttle positions 146 between, and including, the maximum backward throttle position 152 and the maximum forward throttle position 148, including a plurality of forward throttle positions between the neutral throttle position N and the maximum forward throttle position 148 as well as a plurality of backward throttle positions between the neutral throttle position N and the maximum backward throttle position 152. The configuration of the throttle 128 and the throttle assembly 130 will be described in greater detail below.

FIG. 8 illustrates a control system 160 of the patient support apparatus 10. The control system 160 comprises a controller 162 coupled to, among other components, the user interface sensors 132, the throttle assembly 130, the auxiliary interface sensors 140, the auxiliary wheel assembly control circuit 106, the auxiliary wheel actuator 64, the auxiliary wheel drive system 78, the support wheel brake actuator 56, the auxiliary wheel brake actuator 102, and the lift assembly 24.

The controller 162 is configured to operate the auxiliary wheel actuator 64 and the auxiliary wheel drive system 78. The controller 162 may also be configured to operate the support wheel brake actuator 56, the bed lift actuator 26 to operate the lift assembly 24, and the auxiliary wheel brake actuator 102. The controller 162 is generally configured to detect the signals from the sensors and may be further configured to operate the auxiliary wheel actuator 64 responsive to the user interface sensor 132 generating signals responsive to touch.

The controller 162 comprises one or more microprocessors 164 that are coupled to a memory device 166. The memory device 166 may be any memory device suitable for storage of data and computer-readable instructions. For example, the memory device 166 may be a local memory, an external memory, or a cloud-based memory embodied as random access memory (RAM), non-volatile RAM (NVRAM), flash memory, or any other suitable form of memory.

The one or more microprocessors 164 are programmed for processing instructions or for processing algorithms stored in memory 166 to control operation of patient support apparatus 10. For example, the one or more microprocessors 164 may be programmed to control the operation of the auxiliary wheel assembly 60, the support wheel brake actuator 56, and the lift assembly 24 based on user input received via the user interfaces 40. Additionally or alternatively, the controller 162 may comprise one or more microcontrollers, field programmable gate arrays, systems on a chip, discrete circuitry, and/or other suitable hardware, software, or firmware that is capable of carrying out the functions described herein. For example, in some versions, the instructions and/or algorithms executed by the controller 162 may be performed in a state machine configured to execute the instructions and/or algorithms. The controller 162 may be carried on-board the patient support apparatus 10, or may be remotely located. In some versions, the controller 162 may be mounted to the base 14.

The controller 162 comprises an internal clock to keep track of time. In some versions, the internal clock may be realized as a microcontroller clock. The microcontroller clock may comprise a crystal resonator; a ceramic resonator; a resistor, capacitor (RC) oscillator; or a silicon oscillator. Examples of other internal clocks other than those disclosed herein are fully contemplated. The internal clock may be implemented in hardware, software, or both.

In some versions, the memory 166, microprocessors 164, and microcontroller clock cooperate to send signals to and operate the lift assembly 24 and the auxiliary wheel assembly 60 to meet predetermined timing parameters. These predetermined timing parameters are discussed in more detail below and are referred to as predetermined durations.

The controller 162 may comprise one or more subcontrollers configured to control the lift assembly 24 and the auxiliary wheel assembly 60, or one or more subcontrollers for each of the actuators 26, 56, 64, 102, or the auxiliary wheel drive system 78. In some cases, one of the subcontrollers may be attached to the intermediate frame 16 with another attached to the base 14. Power to the actuators 26, 56, 64, 102, the auxiliary wheel drive system 78, and/or the controller 162 may be provided by a battery power supply.

The controller 162 may communicate with auxiliary wheel assembly control circuit 106, the actuators 26, 56, 64, 102, and the auxiliary wheel drive system 78 via wired or wireless connections. The controller 162 generates and transmits control signals to the auxiliary wheel assembly control circuit 106, the actuators 26, 56, 64, 102, and the auxiliary wheel drive system 78, or components thereof, to operate the auxiliary wheel assembly 60 and lift assembly 24 to perform one or more desired functions.

In some versions, and as is shown in FIG. 8, the control system 160 comprises an auxiliary wheel position indicator 168 to display a current position of the auxiliary wheel 62 between or at the deployed position 66 and the retracted position 68, and the one or more intermediate positions. In some versions, the auxiliary wheel position indicator 168 comprises a light bar that lights up completely when the auxiliary wheel 62 is in the deployed position 66 to indicate to the user that the auxiliary wheel 62 is ready to be driven. Likewise, the light bar may be partially lit up when the auxiliary wheel 62 is in a partially retracted position and the light bar may be devoid of light when the auxiliary wheel 62 is in the fully retracted position 68. Other visualization schemes are possible to indicate the current position of the auxiliary wheel 62 to the user, such as other graphical displays, text displays, and the like. Such light indicators or displays are coupled to the controller 162 to be controlled by the controller 162 based on the detected position of the auxiliary wheel 62 as described below. Such indicators may be located on the handle 42 or any other suitable location.

In the illustrated version, the control system 160 comprises a user feedback device 170 coupled to the controller 162 to indicate to the user one of a current speed, a current range of speeds, a current throttle position, and a current range of throttle positions. The user feedback device 170 may be similar to the visual indicators 142 described above, and also provide feedback regarding a current operational mode, current state, condition, etc. of the auxiliary wheel assembly 60. The user feedback device 170 may be placed at any suitable location on the patient support apparatus 10. In some versions, the user feedback device 170 comprises one of a visual indicator, an audible indicator, and a tactile indicator.

The actuators 26, 56, 64, 102 and the auxiliary wheel drive system 78 described above may comprise one or more of an electric actuator, a hydraulic actuator, a pneumatic actuator, combinations thereof, or any other suitable types of actuators, and each actuator may comprise more than one actuation mechanism. The actuators 26, 56, 64, 102 and the auxiliary wheel drive system 78 may comprise one or more of a rotary actuator, a linear actuator, or any other suitable actuators. The actuators 26, 56, 64, 102 and the auxiliary wheel drive system 78 may comprise reversible DC motors, or other types of motors. A suitable actuator for the auxiliary wheel actuator 64 comprises a linear actuator supplied by LINAK A/S located at Smedevænget 8, Guderup, DK-6430, Nordborg, Denmark. It is contemplated that any suitable actuator capable of deploying the auxiliary wheel 62 may be utilized.

The controller 162 is generally configured to operate the auxiliary wheel actuator 64 to move the auxiliary wheel 62 to the deployed position 66 responsive to detection of the signal from the user interface sensor 132. When the user touches the first handle 42, the user interface sensor 132 generates a signal indicating the user is touching the first handle 42 and the controller operates the auxiliary wheel actuator 64 to move the auxiliary wheel 62 to the deployed position 66. In some versions, the controller 162 is further configured to operate the auxiliary wheel actuator 64 to move the auxiliary wheel 62 to the retracted position 68 responsive to the user interface sensor 132 generating a signal indicating the absence of the user touching the first handle 42.

In some versions, the controller 162 is configured to operate the auxiliary wheel actuator 64 to move the auxiliary wheel 62 to the deployed position 66 responsive to detection of the signal from the user interface sensor 132 indicating the user is touching the first handle 42 for a first predetermined duration greater than zero seconds. Delaying operation of auxiliary wheel actuator 64 for the first predetermined duration after the controller 162 detects the signal from the sensor 132 indicating the user is touching the first handle 42 mitigates chances for inadvertent contact to result in operation of the auxiliary wheel actuator 64. In some versions, the controller 162 is configured to initiate operation of the auxiliary wheel actuator 64 to move the auxiliary wheel 62 to the deployed position 66 immediately after (e.g., less than 1 second after) the user interface sensor 132 generates the signal indicating the user is touching the first handle 42.

In some versions, the controller 162 is further configured to operate the auxiliary wheel actuator 64 to move the auxiliary wheel 62 to the retracted position 68, or to the one or more intermediate positions, responsive to the user interface sensor 132 generating a signal indicating the absence of the user touching the first handle 42. In some versions, the controller 162 is configured to operate the auxiliary wheel actuator 64 to move the auxiliary wheel 62 to the retracted position 68, or to the one or more intermediate positions, responsive to the user interface sensor 132 generating the signal indicating the absence of the user touching the first handle 42 for a predetermined duration greater than zero seconds. In some versions, the controller 162 is configured to initiate operation of the auxiliary wheel actuator 64 to move the auxiliary wheel 62 to the retracted position 68, or to the one or more intermediate positions, immediately after (e.g., less than 1 second after) the user interface sensor 132 generates the signal indicating the absence of the user touching the first handle 42.

In versions including the support wheel brake actuator 56 and/or the auxiliary wheel brake actuator 102, the controller 162 may also be configured to operate one or both brake actuators 56, 102 to move their respective brake members 58, 104 between the braked position and the released position. In some versions, the controller 162 is configured to operate one or both brake actuators 56, 102 to move their respective brake members 58, 104 to the braked position responsive to the user interface sensor 132 generating the signal indicating the absence of the user touching the first handle 42 for a predetermined duration. In some versions, the predetermined duration for moving brake members 58, 104 to the braked position is greater than zero seconds. In some versions, the controller 162 is configured to initiate operation of one or both brake actuators 56, 102 to move their respective brake members 58, 104 to the braked position immediately after (e.g., less than 1 second after) the user interface sensor 132 generates the signal indicating the absence of the user touching the first handle 42.

The controller 162 is configured to operate one or both brake actuators 56, 102 to move their respective brake members 58, 104 to the released position responsive to the user interface sensor 132 generating the signal indicating the user is touching the first handle 42 for a predetermined duration. In some versions, the predetermined duration for moving brake members 58, 104 to the released position is greater than zero seconds. In some versions, the controller 162 is configured to initiate operation of one or both brake actuators 56, 102 to move their respective brake members 58, 104 to the released position immediately after (e.g., less than 1 second after) the user interface sensor 132 generates the signal indicating the user is touching the first handle 42.

In some versions, the auxiliary wheel position sensor 118 (also referred to as a “position sensor”) is coupled to the controller 162 and generates signals detected by the controller 162. The auxiliary wheel position sensor 118 is coupled to the controller 162 and the controller 162 is configured to detect the signals from the auxiliary wheel position sensor 118 to detect positions of the auxiliary wheel 62 as the auxiliary wheel 62 moves between the deployed position 66, the one or more intermediate positions, and the retracted position 68.

In some versions, the controller 162 is configured to operate one or both brake actuators 56, 102 to move their respective brake members 58, 104 to the released position responsive to detection of the auxiliary wheel 62 being in the deployed position 66. In some versions, the controller 162 is configured to operate one or both brake actuators 56, 102 to move their respective brake members 58, 104 to the released position responsive to detection of the auxiliary wheel 62 being in a position between the deployed position 66 and the retracted position 68 (e.g., the one or more intermediate positions).

In some versions, an auxiliary wheel load sensor 172 is coupled to the auxiliary wheel 62 and the controller 162, with the auxiliary wheel load sensor 172 configured to generate a signal responsive to a force of the auxiliary wheel 62 being applied to the floor surface. In some versions, the auxiliary wheel load sensor 172 is coupled to the axle of the auxiliary wheel 62. The controller 162 is configured to detect the signal from the auxiliary wheel load sensor 172 and, in some versions, is configured to operate the auxiliary wheel drive system 78 to drive the auxiliary wheel 62 and move the base 14 relative to the floor surface responsive to the controller 162 detecting signals from the auxiliary wheel load sensor 172 indicating the auxiliary wheel 62 is in the partially deployed position engaging the floor surface when a force of the auxiliary wheel 62 on the floor surface exceeds an auxiliary wheel load threshold. This allows the user to drive the auxiliary wheel 62 before the auxiliary wheel 62 reaches the fully deployed position without the auxiliary wheel 62 slipping against the floor surface.

In some versions, a patient load sensor 174 is coupled to the controller 162 and to one of the base 14 and the intermediate frame 16. The patient load sensor 174 generates a signal responsive to weight, such as a patient being disposed on the base 14 and/or the intermediate frame 16. The controller 162 is configured to detect the signal from the patient load sensor 174. Here, the auxiliary wheel load threshold may change based on detection of the signal generated by the patient load sensor 174 to compensate for changes in weight disposed on the intermediate frame 16 and/or the base 14 to mitigate probability of the auxiliary wheel 62 slipping when the controller 162 operates the auxiliary wheel drive system 78.

In some versions, a patient support apparatus leveling sensor 176 is coupled to the controller 162 and to one of the base 14 and the intermediate frame 16. The leveling sensor 176 generates a signal responsive to the horizontal orientation of the base 14. The controller 162 is configured to detect the horizontal orientation of the patient support apparatus 10 based on signals received from the leveling sensor 176 and determine whether the patient support apparatus 10 is positioned on a ramp, an inclined floor surface, a declined floor surface, and/or a substantially flat floor surface.

Each of the sensors described above may comprise one or more of a force sensor, a load cell, a speed radar, an optical sensor, an electromagnetic sensor, an accelerometer, a potentiometer, an infrared sensor, a capacitive sensor, an ultrasonic sensor, a limit switch, a level sensor, a 3-Axis orientation sensor, or any other suitable sensor for performing the functions recited herein. Other configurations are contemplated.

In the illustrated versions, where the auxiliary wheel drive system 78 comprises the motor 80 and the gear train 94, the controller 162 is configured to operate the motor 80 to drive the auxiliary wheel 62 and move the base 14 relative to the floor surface responsive to detection of the auxiliary wheel 62 being in the at least partially deployed position as detected by virtue of the controller 162 detecting the motor 80 drawing electrical power from the power source 84 above an auxiliary wheel power threshold, such as by detecting a change in current draw of the motor 80 associated with the auxiliary wheel 62 being in contact with the floor surface. In this case, detection of the current drawn by the motor 80 being above a threshold operates as a form of auxiliary wheel load sensor 172.

In some versions, when power is not supplied to the motor 80 from the power source 84, the motor 80 acts as a brake to decelerate the auxiliary wheel 62 through the gear train 94. In some versions, the auxiliary wheel 62 is permitted to rotate relatively freely when power is not supplied to the motor 80.

The controller 162 may be programmed to execute the algorithms operating the auxiliary wheel assembly 60 in a plurality of operating modes, as described in U.S. patent application Ser. No. 17/131,947, filed on Dec. 23, 2020, entitled, “Patient Transport Apparatus With Controlled Auxiliary Wheel Speed,” which is hereby incorporated herein by reference. For example, the controller 162 may be programmed to operate the auxiliary wheel assembly 60 in a drive mode, a free wheel mode, a coast mode, a free wheel speed limiting mode, and a drag mode. The controller 162 may also be programmed to quickly turn the modes on/off and quickly toggle between modes in certain scenarios.

The controller 162 may additionally be programmed to detect a position of the throttle assembly 130 determine a desired rotational speed value associated with a current operating throttle position, determine a current rotational speed of the auxiliary wheel 62, select an acceleration rate based on the current rotational speed of the auxiliary wheel 62, generate an output signal based on the selected acceleration rate, and transmit the generated output signal to the motor control circuit 82 to operate the motor 80 to rotate the auxiliary wheel 62 at the selected acceleration rate, as described in U.S. patent application Ser. No. 17/132,009, filed on Dec. 23, 2020, entitled, “Patient Transport Apparatus With Auxiliary Wheel Control Systems,” which is hereby incorporated herein by reference.

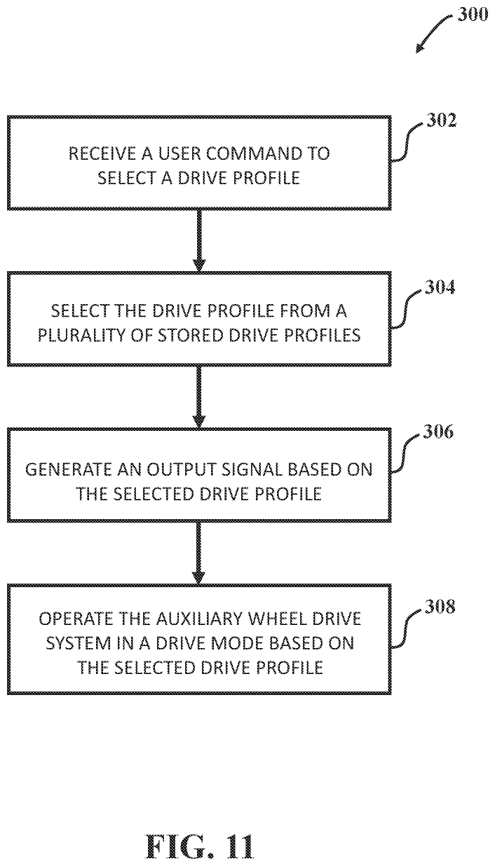

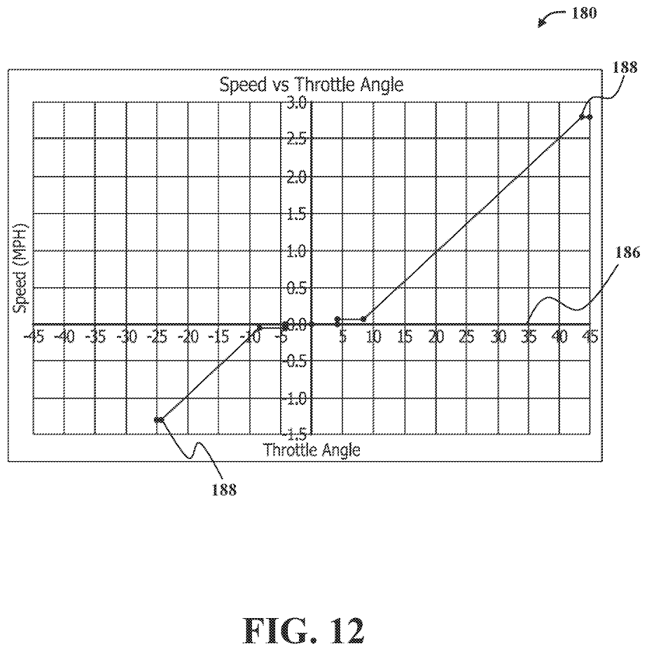

FIG. 11 is a flow chart of method 300 illustrating an algorithm that is executed by the controller 162 to operate the auxiliary wheel assembly 60 in a plurality of drive modes. FIGS. 12-14 illustrate computer data files that may be used by the controller 162 when executing the algorithms illustrated in method 300. The method includes a plurality of steps. Each method step may be performed independently of, or in combination with, other method steps. Portions of the methods may be performed by any one of, or any combination of, the components of the controller 162 and/or the auxiliary wheel assembly control circuit 106. In some versions, the controller 162 may include an auxiliary wheel control module 178 that is configured to execute one more of the algorithms illustrated in method 300. In addition, the auxiliary wheel control module 178 may be configured to operate the auxiliary wheel assembly control circuit 106 to perform one or more of the algorithm steps illustrated in method 300. In some versions, the auxiliary wheel control module 178 may include a state machine configured to execute the steps illustrated in method 300. In some versions, the auxiliary wheel control module 178 may include computer-executable instructions that are stored in the memory device 166 and cause one or more processors 164 of the controller 162 to execute the algorithm steps illustrated in method 300.

In the illustrated version, the controller 162 is also configured to generate a plurality of tables 180, 182, 184 (shown in FIGS. 12-14) for use in executing the method 300. The data tables 180, 182, 184 may be stored as reference database tables in the memory device 166 and/or may be stored as computer-executable instructions for generating the data values included in the data tables 180, 182, 184. In some versions, a state machine may be used to generate the data values included in the data tables 180, 182, 184 that may be used by the auxiliary wheel control module 178 in executing the algorithm shown in method 300.

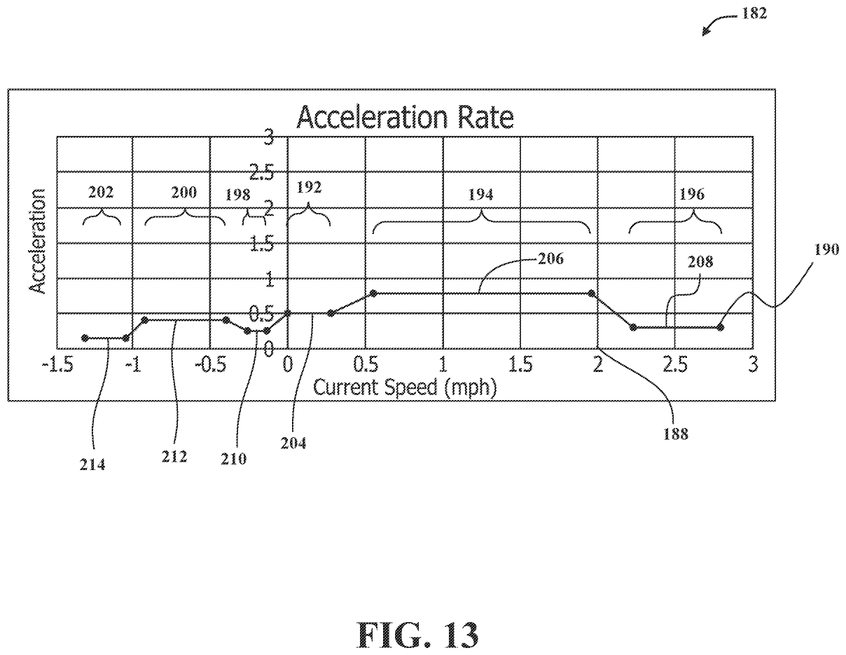

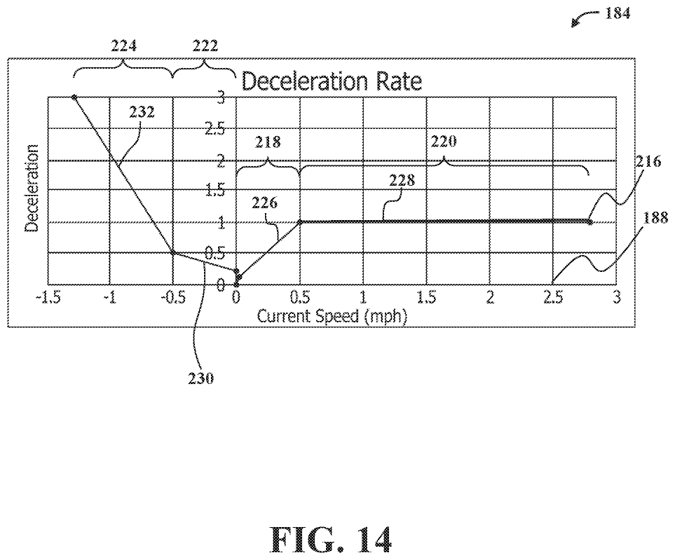

In some versions, the plurality of data tables 180, 182, 184 may include a speed value interpolation table 180 (shown in FIG. 12), an acceleration rate interpolation table 182 (shown in FIG. 13), and/or a deceleration rate interpolation table 184 (shown in FIG. 14). The speed value interpolation table 180 includes a plurality of data values that are used to define a desired rotational speed value of the auxiliary wheel assembly 60 based on the operating throttle positions 146 of the throttle assembly 130. For example, as shown in FIG. 12, the speed value interpolation table 180 includes a plurality of operating throttle position values 186 that are associated with the plurality of rotational speed values 188. The controller 162 may be configured to use the speed value interpolation table 180 to operate the auxiliary wheel assembly 60 to rotate the auxiliary wheel 62 at a rotational speed that is associated with a detected operating throttle position 146. In the illustrated version, each of the operating throttle position values 186 correspond with a throttle angle of the throttle 128 measured about the central axis C with respect to the neutral throttle position N, with the neutral throttle position N representing a zero angle. In some versions, the operating throttle position values 186 may correspond to predefined operating throttle positions 146 and/or a percentage value of an angle of rotation of the throttle 128 measured about the central axis C. In the illustrated version, the rotational speed values 188 represent a corresponding rotational speed of the auxiliary wheel 62 measured in miles per hour. In some versions, the rotational speed values 188 may represent other units of measure such as, for example, feet per second, and/or kilometers per hour. In still other versions, the rotational speed values 188 may be expressed as a percentage of a maximum allowable rotation speed of the auxiliary wheel assembly 60.

Referring to FIG. 13, in some versions, the acceleration rate interpolation table 182 includes a plurality of acceleration rate values 190 that are associated with a plurality of rotational speed values 188. The controller 162 is configured to use the acceleration rate interpolation table 182 to select an acceleration rate of the auxiliary wheel assembly 60 based on a current rotational speed of the auxiliary wheel 62 when a command is received from the user via the user interface 40 and/or the throttle assembly 130. For example, in some versions, the controller 162 may receive a command from the user including detecting a movement of the throttle assembly 130 from the neutral throttle position N to an operating throttle position 146 indicating a desire of the user to adjust the speed of the patient support apparatus 10 using the auxiliary wheel assembly 60. The controller 162 may be configured to access the speed value interpolation table 180 and select a target rotational speed value 188 based on the detected operating throttle position 146. The controller 162 then determines a current rotational speed of the auxiliary wheel 62 upon receiving the command from the user and accesses the acceleration rate interpolation table 182 to select an acceleration rate value 190 based on the current rotational speed of the auxiliary wheel 62. Upon selecting the acceleration rate value 190, the controller 162 operates the auxiliary wheel assembly 60 to adjust the rotational speed of the auxiliary wheel at the selected acceleration rate 190 until the selected target rotational speed value 188 is achieved.

In the illustrated version, the acceleration rate interpolation table 182 includes various groups of rotational speed values having different associated accelerations rates. For example, in some versions, the acceleration rate interpolation table 182 includes groups of forward rotational speed values 192, 194, 196 that are associated with a rotational speed of the auxiliary wheel 62 in the forward direction, and groups of reverse rotational speed values 198, 200, 202 that are associated with a rotational speed of the auxiliary wheel 62 in the backward direction.

In some versions, the acceleration rate interpolation table 182 includes a first group of forward rotational speed values 192 associated with a first acceleration rate 204, a second group of forward rotational speed values 194 associated with a second acceleration rate 206, and a third group of forward rotational speed values 196 associated with a third acceleration rate 208. The second acceleration rate 206 is different than the first acceleration rate 204, and the third acceleration rate 208 is different than the first acceleration rate 204 and the second acceleration rate 206. The first group of forward rotational speed values 192 have lower rotational speed values than the second group of forward rotational speed values 194, and the first acceleration rate 204 is less than the second acceleration rate 206. In addition, the third group of forward rotational speed values 196 have higher rotational speed values than the second group of forward rotational speed values 194, and the third acceleration rate 208 is less than the first acceleration rate 204 and the second acceleration rate 206. In some versions, the acceleration rate interpolation table 182 may include additional groups of forward and reverse rotational speed values that may have different associated acceleration rates. Other configurations are contemplated.

The acceleration rate interpolation table 182 may also include a first group of reverse rotational speed values 198 associated with a fourth acceleration rate 210, a second group of reverse rotational speed values 200 associated with a fifth acceleration rate 212, and a third group of reverse rotational speed values 202 associated with a sixth acceleration rate 214. The fifth acceleration rate 212 is different than the fourth acceleration rate 210, and the sixth acceleration rate 214 is different than the fourth acceleration rate 210 and the fifth acceleration rate 212. The first group of reverse rotational speed values 198 have lower absolute rotational speed values than the second group of reverse rotational speed values 200, and the fourth acceleration rate 210 is less than the fifth acceleration rate 212. The third group of reverse rotational speed values 202 have higher absolute rotational speed values than the second group of reverse rotational speed values 200, and the sixth acceleration rate 214 is less than the fourth acceleration rate 210.

Referring to FIG. 14, in some versions, the deceleration rate interpolation table 184 includes a plurality of deceleration rate values 216 that are associated with a second plurality of rotational speed values 188. The controller 162 is configured to use the deceleration rate interpolation table 184 to select a deceleration rate of the auxiliary wheel assembly 60 based on a current rotational speed of the auxiliary wheel 62 when a command is received from the user via the user interface 40 and/or the throttle assembly 130. In the illustrated version, deceleration rate interpolation table 184 includes various groups of rotational speed values having different associated deceleration rates. For example, in some versions, the deceleration rate interpolation table 184 includes groups of forward rotational speed values 218 and 220 that are associated with a rotational speed of the auxiliary wheel 62 in the forward direction, and groups of reverse rotational speed values 222 and 224 that are associated with a rotational speed of the auxiliary wheel 62 in the backward direction. For example, in some versions, the deceleration rate interpolation table 184 includes a first group of forward rotational speed values 218 associated with a first deceleration rate 226, and a second group of forward rotational speed values 220 associated with a second deceleration rate 228 that is different than the first deceleration rate 226. In addition, the first group of forward rotational speed values 218 have lower rotational speed values than the second group of forward rotational speed values 220, and the first deceleration rate 226 is less than the second deceleration rate 228.

The deceleration rate interpolation table 184 may also include a first group of reverse rotational speed values 222 associated with a fourth deceleration rate 230, and a second group of reverse rotational speed values 224 associated with a fifth deceleration rate 232 that is different than the fourth deceleration rate 230. The first group of reverse rotational speed values 222 have lower absolute rotational speed values than the second group of reverse rotational speed values 224, and the fourth deceleration rate 230 is less than the fifth deceleration rate 232. In some versions, the deceleration rate interpolation table 184 may include additional groups of forward and reverse rotational speed values that may have different associated deceleration rates.

Referring to FIG. 11, in some versions, the controller 162 is programmed to execute the algorithm illustrated in method 300 for operating the patient support apparatus 10 in a drive mode. In method step 302, the controller 162 receives a command from a user to select a first drive profile. For example, in some versions, the controller 162 receives a user input from the graphical user interface 41.

In method step 304, the controller 162 selects the drive profile from a plurality of drive profiles stored in the memory device 166. In some configurations, each of the plurality of stored drive profiles is associated with a location. For example and not by way or limitation, a location may be a medical/healthcare facility. Each of the stored drive profiles may include a plurality of drive mode parameters based on the associated location, which may include, for example, an architectural layout associated with the location and a driver training level associated with the location. An architectural layout associated with a location may include a plurality of features such as: length, width, and shape of hallways; ramps or other features that effect changes in elevation of floor surface; number and width of hallway corners; bridges between buildings of a facility; changes in floor surface; elevators; floors of a building; ingress/egress points of a building; paths, sidewalks, roads, and the like adjacent to one or more buildings; and/or any other feature of the location layout that might affect maneuverability of the patient support apparatus 10 (e.g., locations defined relative to specific units such as med-surge, intensive care, radiology, and the like). A driver training level associated with the location may vary based on whether a particular location has dedicated transport personnel, whether the location requires training of personnel before a user is allowed to use the patient support apparatus 10, and/or other factors that affect how well trained the personnel are to maneuver the patient support apparatus 10.

In method step 306, the controller 162 is configured to generate a signal based on the selected drive profile. For example, the controller 162 may be programmed to generate an output PWM signal based on the selected acceleration rate. In some versions, the controller 162 may be configured to monitor an electrical current draw from the power source 84 by the motor 80 and generate the output signal based on the selected acceleration rate and the monitored electrical current draw from the power source 84.

In method step 308, the controller 162 is configured to transmit the generated output signal to the motor control circuit 82 to operate the auxiliary wheel drive system 78 in a drive mode based on the selected drive profile. For example, the controller 162 may be configured to transmit the generated output signal to the motor control circuit 82 for operating the plurality of FET switches 88 of the motor control circuit 82 to control the speed, acceleration, and rotational direction of the motor 80 to rotate the auxiliary wheel 62 based on the selected drive profile.

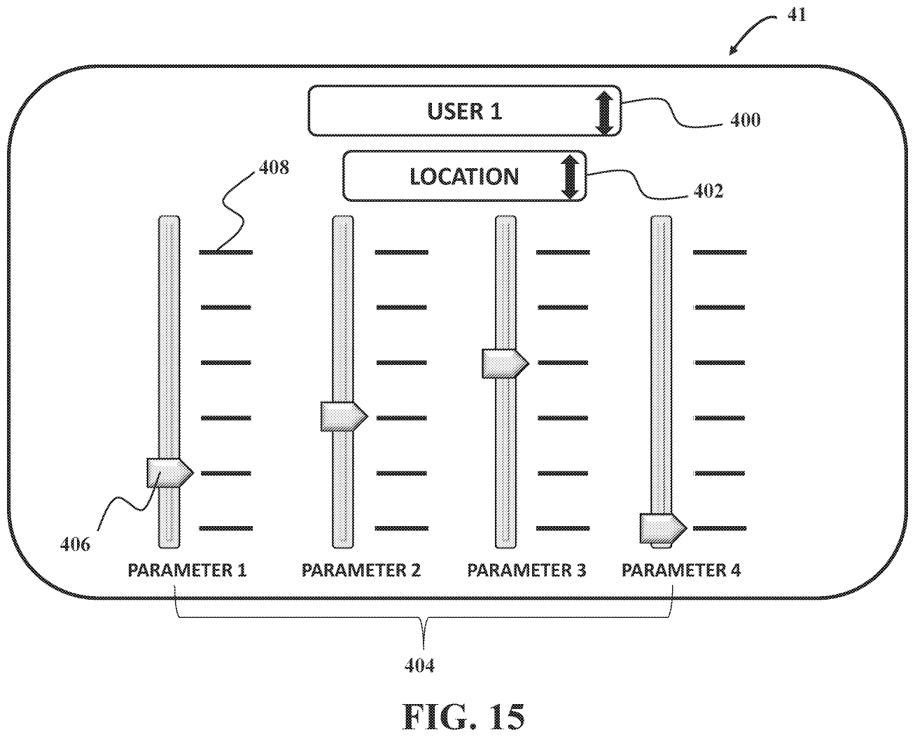

Referring to FIG. 15, graphical user interface 41 is illustrated. The graphical user interface 41 may receive user commands from a user to operate the auxiliary wheel assembly 60. A user of the graphical user interface 41 may be chosen from a plurality of users from a user menu 400 (e.g., via a drop-down list as indicated by the arrow shown in FIG. 15). By way of example and not limitation, the plurality of users may include all personnel employed by or associated with a single facility, or all personnel employed by or associated with a single owner (e.g., a hospital system or healthcare group) across more than one facility. In some configurations, the user may engage directly with the graphical user interface 41 to make a selection (e.g., by manually entering information, which may require a password or other security token before the user is permitted to make any selections). In yet other configurations, a physical security token (e.g., an access card or USB dongle) may be recognized by the graphical user interface 41 and/or the controller 162 to authenticate a user. In yet other versions, an electronic security token may be recognized by the graphical user interface 41 and/or the controller 162 to authenticate a user (e.g., Bluetooth, NFC, RFID, and/or Ultra-wideband signals).

A location of the graphical user interface 41 may be chosen from a plurality of locations from a location menu 402 (e.g., via a drop-down list as indicated by the arrow shown in FIG. 15). By way of example and not limitation, the plurality of locations may be all facilities associated with one owner (e.g., a hospital system or healthcare group) or within a predefined geographical area. In some configurations, a user may choose a location from the plurality of locations. In yet other configurations, a location may be chosen automatically based on the user selected from the user menu 400. For example, if a given user is only associated with a single facility, the user may not be permitted to select a different facility even if the owner of the facility operates more than one facility. In yet other versions, the patient support apparatus 10 may automatically detect and select its location. The controller 162 may be programmed to detect a location of the patient support apparatus 10, and determine a drive profile or a plurality of drive profiles associated with the current location (e.g., a facility or a particular floor within a facility) as described in U.S. patent application Ser. No. 15/910,507, filed on Mar. 2, 2018, entitled, “Techniques for Dynamic Mapping of a Facility Using Patient Transport Apparatuses,” which is hereby incorporated herein by reference. In some versions, the controller 162 may be configured to detect the location of the patient support apparatus 10 by receiving signals associated with one or more devices, sensors, and the like either onboard of the patient support apparatus 10 or from external devices, tracking systems, and the like, including without limitation signals generated based on interaction with devices via Bluetooth, NFC, RFID, and/or Ultra-wideband signals. Other configurations are contemplated.

The graphical user interface 41 may further include one or more drive mode parameters 404. In some configurations, the drive mode parameters 404 may be preset and non-adjustable based on the selected drive profile (e.g., based on the user and/or location). For example, a facility may set a drive profile for all its patient support apparatuses 10 based on a location that is non-adjustable by any user, and changes to such drive profile may only be initiated by an administrator. In other configurations, the facility may set a limited set of drive profiles for all its patient support apparatuses 10 based on a location that are non-adjustable by any user, and changes to such drive profile may only be initiated by an administrator. However, in this configuration, the user may select one of the limited set of drive profiles for the specified location.

In yet other configurations, a facility may set a drive profile based on a user (which may be based on, for example, a training level associated with the user) that is non-adjustable by the user, and changes to such drive profiles may only be initiated by an administrator. In yet other configurations, one or more of the drive mode parameters 404 may be adjustable by the user within certain ranges. In other configurations, the facility may set a limited set of drive profiles for the user that are non-adjustable by the user, and changes to such drive profiles may only be initiated by an administrator. However, in this configuration, the user may select one of the limited set of drive profiles for the specified user.

The drive mode parameters 404 may include, for example and not limitation, a rotational speed of the auxiliary wheel, an acceleration rate of the auxiliary wheel, a deceleration rate of the auxiliary wheel, a power setting, and a safety setting. One or more drive mode parameters described herein may be defined as discrete values, target values over time, limits such as maximum and/or minimum values, and the like. In some versions, one or more drive mode parameters may be limited in various ways (e.g., within ranges and/or for certain time periods) for certain users, within certain locations, and the like. Other configurations are contemplated. A power setting may include detection of a battery charge threshold. In some configurations, the patient support apparatus 10 may not deploy when a selected drive profile requires more power than the current battery charge (e.g., the drive profile is aggressive, with a high maximum speed and/or high acceleration or deceleration rate, or when the drive profile anticipates many inclines, such as ramps, that require more power for navigating). Each of the drive mode parameters 404 may include a parameter selector, one of which is labeled 406. In some configurations, the selector 406 may be a slider that is adjustable between one or more positions, one of which is labeled 408. Each of the positions 408 may correspond with a value or range of values associated with the drive mode parameter 404.

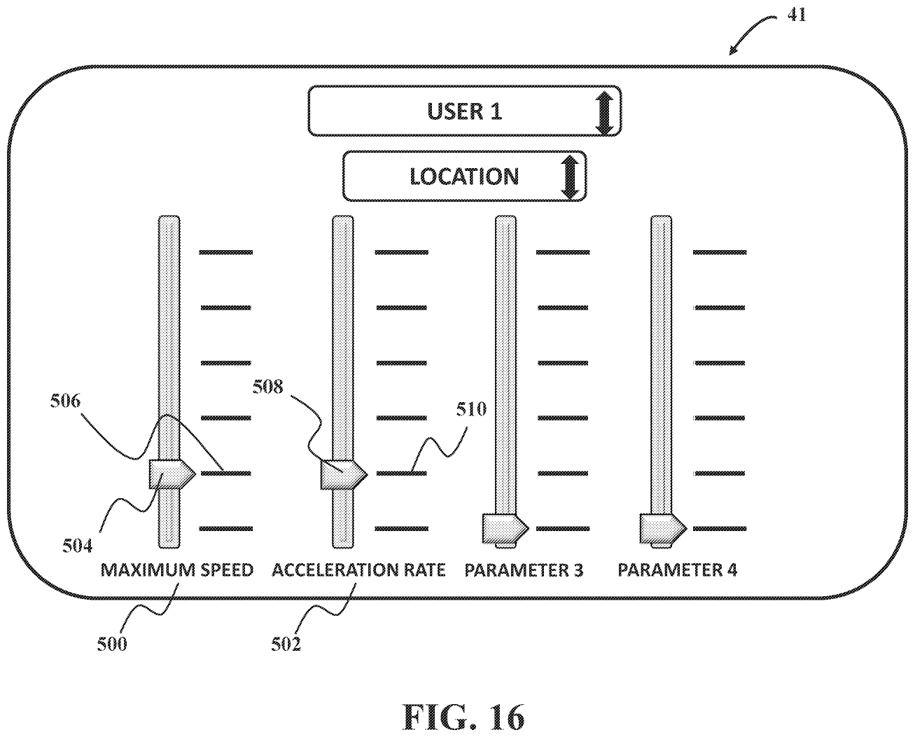

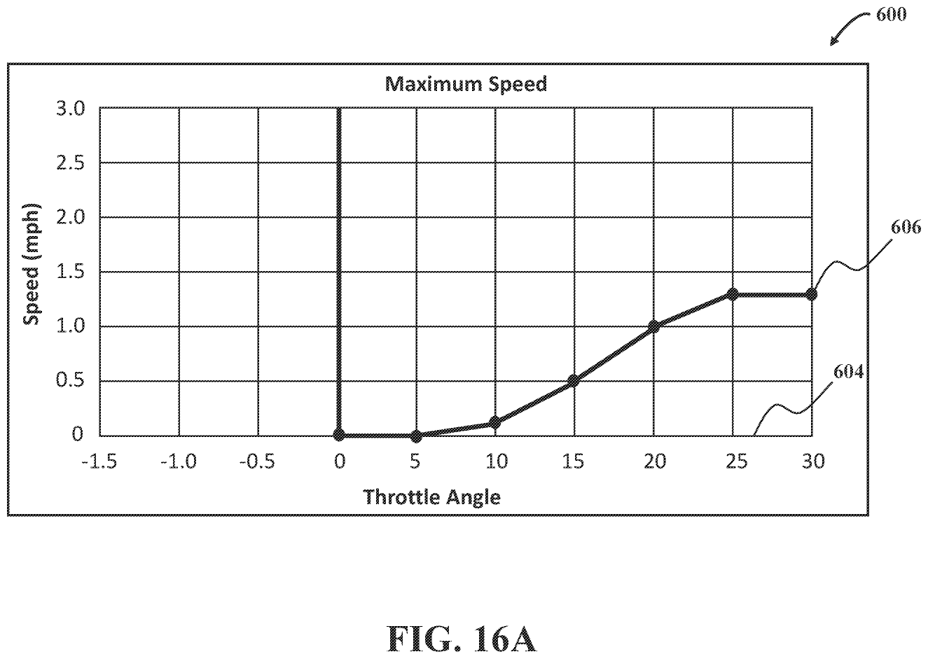

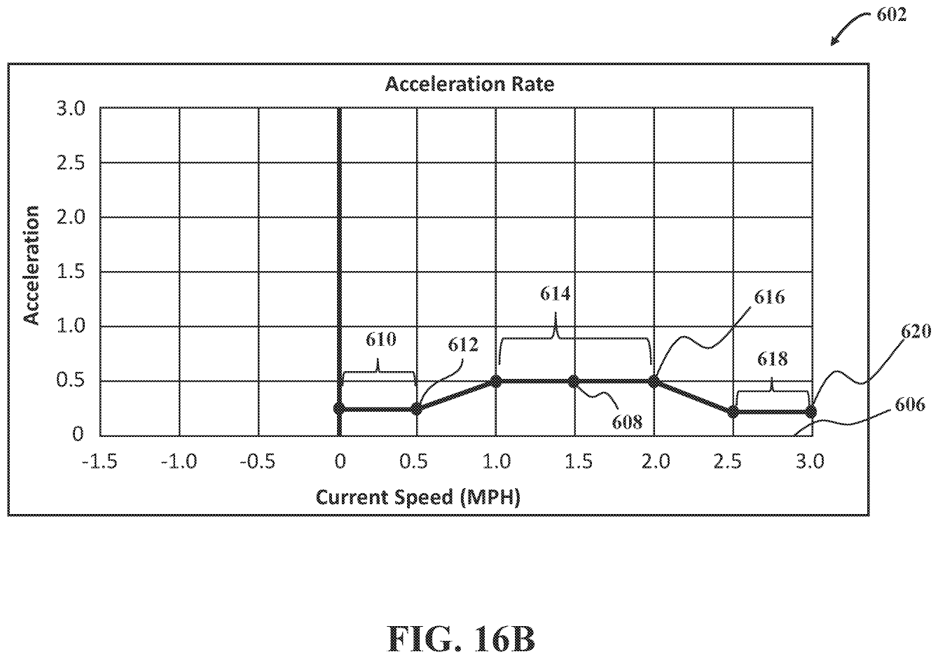

Referring to FIG. 16, the graphical user interface 41 may receive user commands from a user to operate the auxiliary wheel assembly 60 in a first drive mode based on a selected drive profile (see step 308, method 300 of FIG. 11). The first drive mode may be associated with one or more drive mode parameters (e.g., the drive mode parameters 404 of FIG. 15).

In the illustrated configuration, the first drive mode parameter 500 is a maximum speed of the auxiliary wheel assembly 60. The first drive mode parameter 500 may be adjustable using a first parameter selector 504. In some configurations, the first parameter selector 504 may be a slider that is adjustable between one or more positions, one of which is labeled 506. As shown, the selected position 506 may be associated with a lower maximum speed of the auxiliary wheel assembly 60. In the illustrated configuration, the second drive mode parameter 502 is an acceleration rate of the auxiliary wheel assembly 60. The second drive mode parameter 502 may be adjustable using a second parameter selector 508. In some configurations, the second parameter selector 508 may be a slider that is adjustable between one or more positions, one of which is labeled 510. As shown, the selected position 510 may be associated with a lower acceleration rate of the auxiliary wheel assembly 60. A lower maximum speed and/or acceleration rate may be desirable in certain scenarios, for example, in facilities that include numerous ramps, uneven surfaces, large elevation changes, tight corners, narrow hallways, or any other facility layout that is likely to make maneuvering the patient support apparatus 10 more difficult at higher speeds. For example, facilities with large elevation changes and/or numerous ramps may use a drive profile with enhanced ramp detection and/or power settings to ensure safety on inclines.

Referring to FIGS. 16A-16B, data files that may be used with an algorithm illustrated that may be executed by the control system 160 of the patient support apparatus 10 shown in FIG. 11, according to the drive mode shown in FIG. 16, are illustrated. The data tables 600, 602 may be stored as reference database tables in the memory device 166 and/or may be stored as computer-executable instructions for generating the data values included in the data tables 600, 602. In some versions, a state machine may be used to generate the data values included in the data tables 600, 602 that may be used by the auxiliary wheel control module 178 in executing the algorithm shown in method 300.

In some versions, the plurality of data tables 600, 602 include a speed value interpolation table 600 (shown in FIG. 16A) and an acceleration rate interpolation table 602 (shown in FIG. 16B). The speed value interpolation table 600 includes a plurality of data values that are used to define a desired rotational speed value of the auxiliary wheel assembly 60 based on the selected drive profile. For example, as shown in FIG. 16A, the speed value interpolation table 600 includes a plurality of throttle position values 604 that are associated with the plurality of rotational speed values 606. The controller 162 may be configured to use the speed value interpolation table 600 to operate the auxiliary wheel assembly 60 to rotate the auxiliary wheel 62 at a rotational speed that is associated with a detected throttle position 604. In the illustrated version, each of the throttle position values 604 correspond with a throttle angle of the throttle 128 measured about the central axis C with respect to the neutral throttle position N, with the neutral throttle position N representing a zero angle. In some versions, the throttle position values 604 may correspond to predefined operating throttle positions 146 and/or a percentage value of an angle of rotation of the throttle 128 measured about the central axis C. In the illustrated version, the rotational speed values 606 represent a corresponding rotational speed of the auxiliary wheel 62 measured in miles per hour. In some versions, the rotational speed values 606 may represent other units of measure such as, for example, feet per second, and/or kilometers per hour. In still other versions, the rotational speed values 606 may be expressed as a percentage of a maximum allowable rotation speed of the auxiliary wheel assembly 60.

Referring to FIG. 16B, in some versions, the acceleration rate interpolation table 602 includes a plurality of acceleration rate values 608 that are associated with a plurality of rotational speed values 606. The controller 162 is configured to use the acceleration rate interpolation table 602 to select an acceleration rate of the auxiliary wheel assembly 60 based on a current rotational speed of the auxiliary wheel 62 when a command is received from the user via the graphical user interface 41. The controller 162 may be configured to access the speed value interpolation table 602 and select a target rotational speed value 606 based on the selected drive profile and/or adjusted drive mode parameter. The controller 162 then determines a current rotational speed of the auxiliary wheel 62 upon receiving the command from the user and accesses the acceleration rate interpolation table 602 to select an acceleration rate value 608 based on the current rotational speed of the auxiliary wheel 62. Upon selecting the acceleration rate value 608, the controller 162 operates the auxiliary wheel assembly 60 to adjust the rotational speed of the auxiliary wheel at the selected acceleration rate 608 until the selected target rotational speed value 606 is achieved.

In some versions, the acceleration rate interpolation table 602 includes a first group of forward rotational speed values 610 associated with a first acceleration rate 612, a second group of forward rotational speed values 614 associated with a second acceleration rate 616, and a third group of forward rotational speed values 618 associated with a third acceleration rate 620. The second acceleration rate 616 is different than the first acceleration rate 612, and the third acceleration rate 620 is different than the first acceleration rate 612 and the second acceleration rate 616. The first group of forward rotational speed values 610 have lower rotational speed values than the second group of forward rotational speed values 614, and the first acceleration rate 612 is less than the second acceleration rate 616. In addition, the third group of forward rotational speed values 618 have higher rotational speed values than the second group of forward rotational speed values 614 and the third acceleration rate 620 is less than the first acceleration rate 612 and the second acceleration rate 616. In some versions, the acceleration rate interpolation table 602 may include additional groups of forward and reverse rotational speed values that may have different associated acceleration rates.

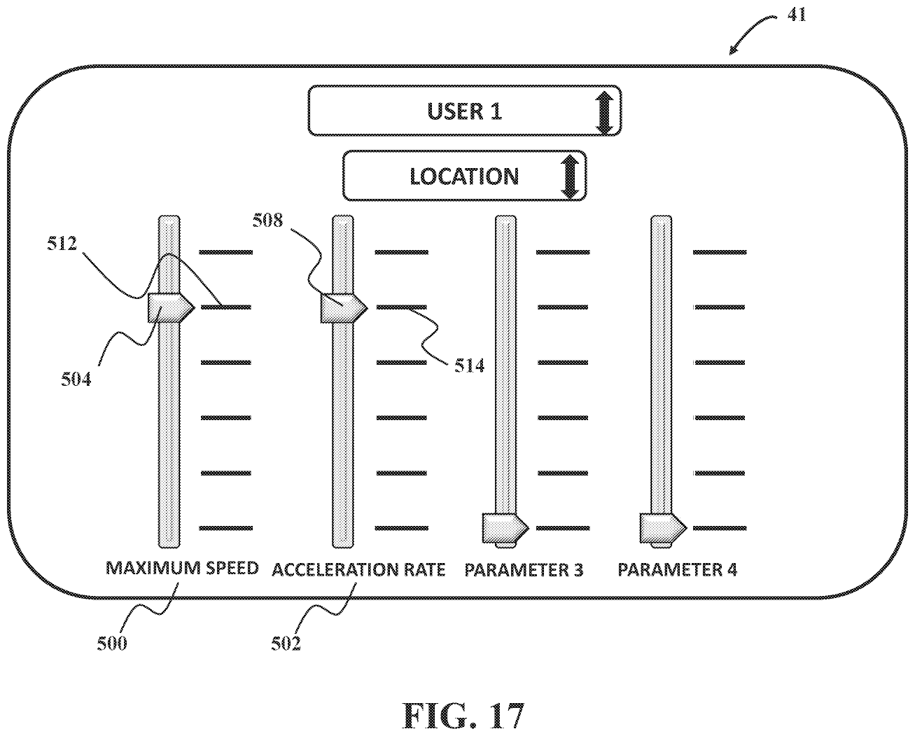

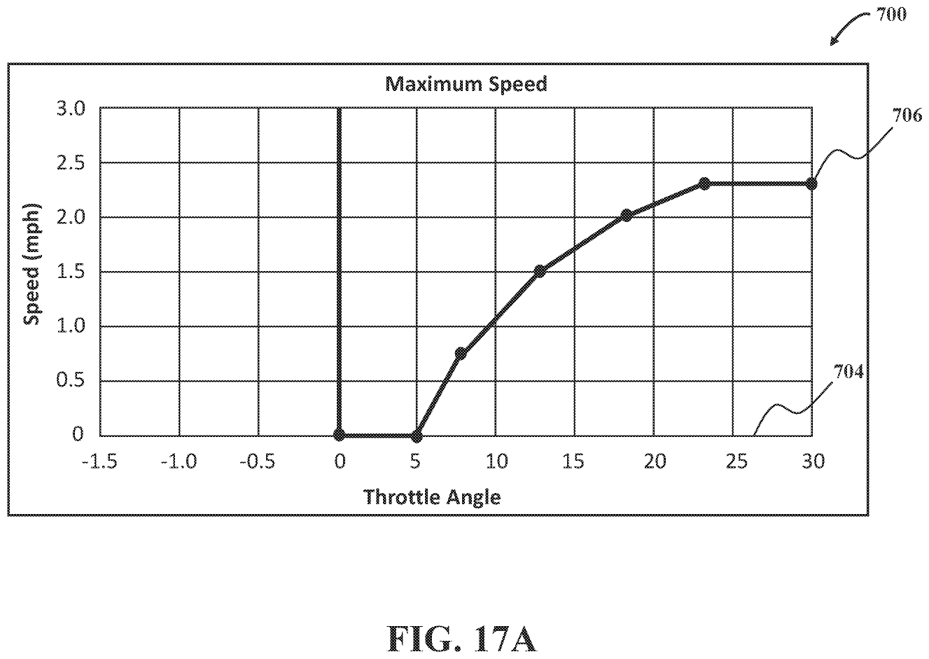

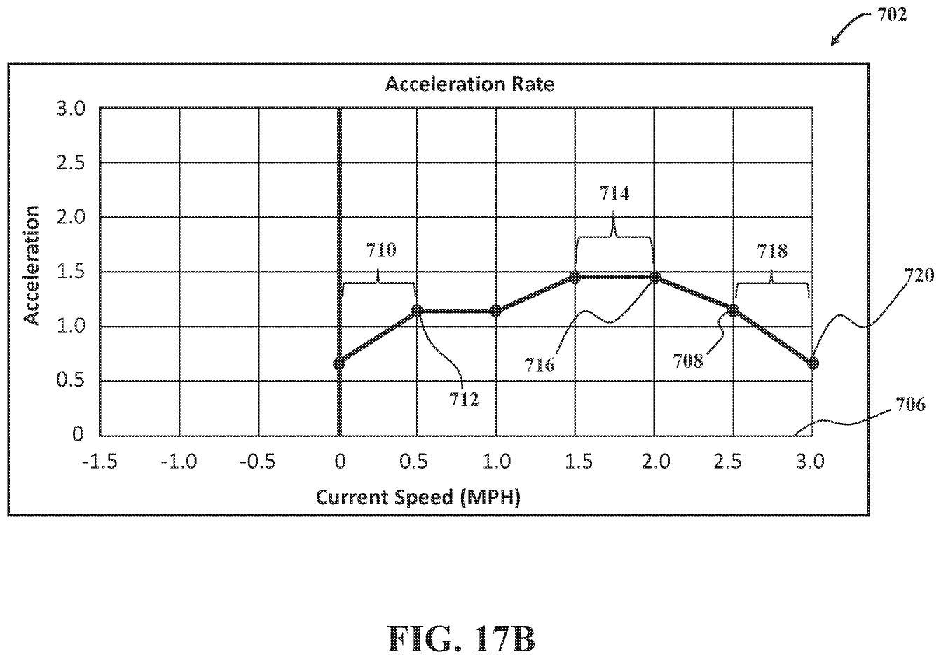

Referring to FIG. 17, the graphical user interface 41 may receive user commands from a user to operate the auxiliary wheel assembly 60 in a second drive mode based on a selected drive profile (see step 308, method 300 of FIG. 11). The second drive mode may be associated with one or more drive mode parameters (e.g., the drive mode parameters 404 of FIG. 15).

In the illustrated configuration, the second drive mode includes the first drive mode parameter 500, which is maximum speed, and the second drive mode parameter 502, which is acceleration rate, of FIG. 16. The first parameter selector 504 is adjusted to position 512, and the second parameter selector 508 is adjusted to a position 514. As shown, the selected positions 512, 514 may be associated with a higher maximum speed and acceleration rate, respectively, of the auxiliary wheel assembly 60. A higher maximum speed and/or acceleration rate may be desirable in certain scenarios, for example, in facilities that include a large number of long, straight and/or wide hallways, few ramps/elevation changes, or any other facility layout that is likely to make maneuvering the patient support apparatus 10 less difficult at higher speeds.

Referring to FIGS. 17A-17B, data files that may be used with an algorithm illustrated that may be executed by the control system 160 of the patient support apparatus 10 shown in FIG. 11, according to the drive mode shown in FIG. 17, are illustrated.

The data tables 700, 702 may be stored as reference database tables in the memory device 166 and/or may be stored as computer-executable instructions for generating the data values included in the data tables 700, 702. In some versions, a state machine may be used to generate the data values included in the data tables 700, 702 that may be used by the auxiliary wheel control module 178 in executing the algorithm shown in method 300.

In some versions, the plurality of data tables 700, 702 include a speed value interpolation table 700 (shown in FIG. 17A) and an acceleration rate interpolation table 702 (shown in FIG. 17B). The speed value interpolation table 700 includes a plurality of data values that are used to define a desired rotational speed value of the auxiliary wheel assembly 60 based on the selected drive profile. For example, as shown in FIG. 17A, the speed value interpolation table 700 includes a plurality of throttle position values 704 that are associated with the plurality of rotational speed values 706. The controller 162 may be configured to use the speed value interpolation table 700 to operate the auxiliary wheel assembly 60 to rotate the auxiliary wheel 62 at a rotational speed that is associated with a detected throttle position 704. In the illustrated version, each of the throttle position values 704 correspond with a throttle angle of the throttle 128 measured about the central axis C with respect to the neutral throttle position N, with the neutral throttle position N representing a zero angle. In some versions, the throttle position values 704 may correspond to predefined operating throttle positions 146 and/or a percentage value of an angle of rotation of the throttle 128 measured about the central axis C. In the illustrated version, the rotational speed values 706 represent a corresponding rotational speed of the auxiliary wheel 62 measured in miles per hour. In some versions, the rotational speed values 706 may represent other units of measure such as, for example, feet per second, and/or kilometers per hour. In still other versions, the rotational speed values 706 may be expressed as a percentage of a maximum allowable rotation speed of the auxiliary wheel assembly 60.

Referring to FIG. 17B, in some versions, the acceleration rate interpolation table 702 includes a plurality of acceleration rate values 708 that are associated with a plurality of rotational speed values 706. The controller 162 is configured to use the acceleration rate interpolation table 702 to select an acceleration rate of the auxiliary wheel assembly 60 based on a current rotational speed of the auxiliary wheel 62 when a command is received from the user via the graphical user interface 41. The controller 162 may be configured to access the speed value interpolation table 702 and select a target rotational speed value 706 based on the selected drive profile and/or adjusted drive mode parameter. The controller 162 then determines a current rotational speed of the auxiliary wheel 62 upon receiving the command from the user and accesses the acceleration rate interpolation table 702 to select an acceleration rate value 708 based on the current rotational speed of the auxiliary wheel 62. Upon selecting the acceleration rate value 708, the controller 162 operates the auxiliary wheel assembly 60 to adjust the rotational speed of the auxiliary wheel at the selected acceleration rate 708 until the selected target rotational speed value 706 is achieved.

In some versions, the acceleration rate interpolation table 702 includes a first group of forward rotational speed values 710 associated with a first acceleration rate 712, a second group of forward rotational speed values 714 associated with a second acceleration rate 716, and a third group of forward rotational speed values 718 associated with a third acceleration rate 720. The second acceleration rate 716 is different than the first acceleration rate 712, and the third acceleration rate 720 is different than the first acceleration rate 712 and the second acceleration rate 716. The first group of forward rotational speed values 710 have lower rotational speed values than the second group of forward rotational speed values 714, and the first acceleration rate 712 is less than the second acceleration rate 716. In addition, the third group of forward rotational speed values 718 have higher rotational speed values than the second group of forward rotational speed values 714 and the third acceleration rate 720 is less than the first acceleration rate 712 and the second acceleration rate 716. In some versions, the acceleration rate interpolation table 702 may include additional groups of forward and reverse rotational speed values that may have different associated acceleration rates.

In some versions, speed and/or acceleration control is carried out to provide: i) lower accelerations and/or lower speeds in facilities that have layouts that are more difficult to maneuver patient support apparatus 10 and/or personnel with lower levels of training to operate patient support apparatus 10; and ii) higher accelerations and/or higher speeds in facilities that have layouts that are easier to maneuver patient support apparatus 10 and/or personnel with higher levels of training to operate patient support apparatus 10.

Several configurations have been discussed in the foregoing description. However, the configurations discussed herein are not intended to be exhaustive or limit the invention to any particular form. The terminology which has been used is intended to be in the nature of words of description rather than of limitation. Many modifications and variations are possible in light of the above teachings and the invention may be practiced otherwise than as specifically described.

The present disclosure also comprises the following clauses, with specific features laid out in dependent clauses, that may specifically be implemented as described in greater detail with reference to the configurations and drawings above.

### Clauses

I. A patient support apparatus comprising:
a support structure;
a support wheel coupled to the support structure;
a drive system including a drive member coupled to the support structure to influence motion of the patient support apparatus over a floor surface, a motor coupled to the drive member to operate the drive member at a speed, and a motor control circuit for transmitting power signals from a power source to the motor;
a graphical user interface for receiving user commands from a user to operate the drive system; and
a control system coupled to the graphical user interface and the drive system for operating the drive system, the control system including a memory device configured to store a plurality of drive profiles, and a controller coupled to the memory device and configured to:
   receive a first user command to select a first drive profile,
   select the first drive profile from the plurality of stored drive profiles,
   generate an output signal based on the selected first drive profile, and
   transmit the generated output signal to the motor control circuit to operate the motor to operate the drive member in a first drive mode based on the selected first drive profile.
II. The patient support apparatus of clause I, wherein the first drive mode includes a first drive mode parameter.
III. The patient support apparatus of clause II, wherein the first drive mode parameter includes one of: a rotational speed of the drive member, an acceleration rate of the drive member, a deceleration rate of the drive member, and a power setting.
IV. The patient support apparatus of any of clauses I-III, wherein the controller is further configured to:
receive a second user command to select a second drive profile;
select the second drive profile from the plurality of stored drive profiles;
generate an output signal based on the selected second drive profile; and
transmit the generated output signal to the motor control circuit to operate the motor to operate the drive member in a second drive mode based on the selected second drive profile.
V. The patient support apparatus of clause IV, wherein:
   the first drive mode includes a first drive mode parameter;
   the second drive mode includes a second drive mode parameter; and
   the first drive mode parameter is different from the second drive mode parameter.
VI. The patient support apparatus of clause V, wherein the first drive mode parameter and the second drive mode parameter include one of: a rotational speed of the drive member, an acceleration rate of the drive member, a deceleration rate of the drive member, and a power setting.
VII. The patient support apparatus of any of clauses I-VI, wherein each of the plurality of stored drive profiles is associated with a location.
VIII. The patient support apparatus of clause VII, wherein a location associated with one of the plurality of stored drive profiles is a medical facility.
IX. The patient support apparatus of any of clauses VII-VIII, wherein each of the plurality of stored drive profiles includes a plurality of drive mode parameters defined based on the location.
X. The patient support apparatus of clause IX, wherein one or more of the plurality of drive mode parameters is adjustable by the user.
XI. The patient support apparatus of any of clauses IX-X, wherein at least one of the plurality of drive mode parameters is defined based on an architectural layout associated with the location.
XII. The patient support apparatus of any of clauses IX-XI, wherein at least one of the plurality of drive mode parameters is defined based on a driver training level associated with the location.
XIII. The patient support apparatus of any of clauses I-XII, wherein the first user command is based on user engagement with the graphical user interface.
XIV. The patient support apparatus of any of clauses I-XIII, wherein the first user command is based on a recognized physical security token.
XV. The patient support apparatus of any of clauses I-XIV, wherein the first user command is based on a recognized electronic security token.
XVI. A patient support apparatus comprising:
   a support structure;
   a support wheel coupled to the support structure;
   a drive system including a drive member coupled to the support structure to influence motion of the patient support apparatus over a floor surface, a motor coupled to the drive member to operate the drive member at a speed, and a motor control circuit for transmitting power signals from a power source to the motor; and
   a control system coupled to the drive system for operating the drive system, the control system including a memory device configured to store a plurality of drive profiles, and a controller coupled to the memory device and configured to:
      detect a first drive profile based on at least one of a user input and a location associated with the patient support apparatus,
      select the first drive profile from the plurality of stored drive profiles,
      generate an output signal based on the selected first drive profile, and
      transmit the generated output signal to the motor control circuit to operate the motor to operate the drive member in a first drive mode based on the selected first drive profile.
XVII. The patient support apparatus of clause XVI, wherein the first drive mode includes a first drive mode parameter.
XVIII. The patient support apparatus of clause XVII, wherein the first drive mode parameter includes one of: a rotational speed of the drive member, an acceleration rate of the drive member, a deceleration rate of the drive member, and a power setting.
XIX. The patient support apparatus of any of clauses XVI-XVIII, wherein the controller is further configured to:
   receive a second user command to select a second drive profile;
   select the second drive profile from the plurality of stored drive profiles;
   generate an output signal based on the selected second drive profile; and
   transmit the generated output signal to the motor control circuit to operate the motor to operate the drive member in a second drive mode based on the selected second drive profile.
XX. The patient support apparatus of clause XIX, wherein:
   the first drive mode includes a first drive mode parameter;
   the second drive mode includes a second drive mode parameter; and
   the first drive mode parameter is different from the second drive mode parameter.
XXI. The patient support apparatus of clause XX, wherein the first drive mode parameter and the second drive mode parameter include one of: a rotational speed of the drive member, an acceleration rate of the drive member, a deceleration rate of the drive member, and a power setting.
XXII. The patient support apparatus of any of clauses XVI-XXI, wherein each of the plurality of stored drive profiles is associated with a location.
XXIII. The patient support apparatus of clause XXII, wherein a location associated with one of the plurality of stored drive profiles is a medical facility.
XXIV. The patient support apparatus of any of clauses XVI-XXIII, wherein each of the plurality of stored drive profiles includes a plurality of drive mode parameters defined based on the location.
XXV. The patient support apparatus of clause XXIV, wherein one or more of the plurality of drive mode parameters is adjustable by the user.
XXVI. The patient support apparatus of any of clauses XXIV-XXV, wherein at least one of the plurality of drive mode parameters is defined based on an architectural layout associated with the location.
XXVII. The patient support apparatus of any of clauses XXIV-XXVI, wherein at least one of the plurality of drive mode parameters is defined based on a driver training level associated with the location.
XXVIII. The patient support apparatus of any of clauses XVI-XXVII, further comprising a graphical user interface for receiving user commands from a user to operate the drive system.
XXIX. The patient support apparatus of clause XXVIII, wherein the controller is further configured to detect the first drive profile based on user engagement with the graphical user interface.
XXX. The patient support apparatus of any of clauses XVI-XXIX, wherein the controller is further configured to detect the first drive profile based on a recognized physical security token.
XXXI. The patient support apparatus of any of clauses XVI-XXX, wherein the controller is further configured to detect the first drive profile based on a recognized electronic security token.
XXXII. A patient support apparatus comprising:
a support structure;
a support wheel coupled to the support structure;
a drive system including a drive member coupled to the support structure to influence motion of the patient support apparatus over a floor surface, a motor coupled to the drive member to operate the drive member at a speed, and a motor control circuit for transmitting power signals from a power source to the motor; and
a control system coupled to the drive system for operating the drive system, the control system including a memory device configured to store a plurality of drive profiles, and a controller coupled to the memory device and configured to:
   detect a first location of the patient support apparatus,
   select a first drive profile from the plurality of stored drive profiles based on the location of the patient support apparatus,
   generate an output signal based on the selected first drive profile, and
   transmit the generated output signal to the motor control circuit to operate the motor to operate the drive member in a first drive mode based on the selected first drive profile.
XXXIII. The patient support apparatus of clause XXXII, wherein the controller is further configured to:
detect a second location associated with the patient support apparatus,
select a second drive profile from the plurality of stored drive profiles based on the second location;
generate an output signal based on the selected second drive profile; and
transmit the generated output signal to the motor control circuit to operate the motor to operate the drive member in a second drive mode based on the selected second drive profile.
XXXIV. The patient support apparatus of clause XXXIII, wherein:
the first drive mode includes a first drive mode parameter,
the second drive mode includes a second drive mode parameter, and the first drive mode parameter is different from the second drive mode parameter.
XXXV. The patient support apparatus of clause XXXIV, wherein the first drive mode parameter and the second drive mode parameter include one of: a rotational speed of the drive member, an acceleration rate of the drive member, a deceleration rate of the drive member, and a power setting.
XXXVI. A method of operating a drive system coupled to a patient support apparatus, the drive system including a drive member for influencing motion of the patient support apparatus over a floor surface with a motor coupled to the drive member to operate the drive member at a speed and with a motor control circuit for transmitting power signals from a power source to the motor, a graphical user interface for receiving user commands from a user to operate the drive system, and a control system coupled to the graphical user interface and the drive system, the control system including a memory device configured to store a plurality of drive profiles, and a controller coupled to the memory device, the method including the control system executing the steps of:
receiving a first user command to select a first drive profile;
selecting the first drive profile from the plurality of stored drive profiles;
generating an output signal based on the selected first drive profile; and
transmitting the generated output signal to the motor control circuit to operate the motor to operate the drive member in a first drive mode based on the selected first drive profile.

1. A patient support apparatus comprising:
a support structure;
a support wheel coupled to the support structure;
a drive system including a drive member coupled to the support structure to influence motion of the patient support apparatus over a floor surface, a motor coupled to the drive member to operate the drive member at a speed, and a motor control circuit for transmitting power signals from a power source to the motor;
a graphical user interface for receiving user commands from a user to operate the drive system; and
a control system coupled to the graphical user interface and the drive system for operating the drive system, the control system including a memory device configured to store a plurality of drive profiles, and a controller coupled to the memory device and configured to:
receive a first user command to select a first drive profile,
select the first drive profile from the plurality of stored drive profiles,
generate an output signal based on the selected first drive profile, and
transmit the generated output signal to the motor control circuit to operate the motor to operate the drive member in a first drive mode based on the selected first drive profile.

2. The patient support apparatus of claim 1, wherein the first drive mode includes a first drive mode parameter.

3. The patient support apparatus of claim 2, wherein the first drive mode parameter includes one of: a rotational speed of the drive member, an acceleration rate of the drive member, a deceleration rate of the drive member, and a power setting.

4. The patient support apparatus of claim 1, wherein the controller is further configured to:
receive a second user command to select a second drive profile;
select the second drive profile from the plurality of stored drive profiles;
generate an output signal based on the selected second drive profile; and
transmit the generated output signal to the motor control circuit to operate the motor to operate the drive member in a second drive mode based on the selected second drive profile.

5. The patient support apparatus of claim 4, wherein:
the first drive mode includes a first drive mode parameter;
the second drive mode includes a second drive mode parameter; and
the first drive mode parameter is different from the second drive mode parameter.

6. The patient support apparatus of claim 5, wherein the first drive mode parameter and the second drive mode parameter include one of: a rotational speed of the drive member, an acceleration rate of the drive member, a deceleration rate of the drive member, and a power setting.

7. The patient support apparatus of claim 1, wherein each of the plurality of stored drive profiles is associated with a location.

8. The patient support apparatus of claim 7, wherein a location associated with one of the plurality of stored drive profiles is a medical facility.

9. The patient support apparatus of claim 7, wherein each of the plurality of stored drive profiles includes a plurality of drive mode parameters defined based on the location.

10. The patient support apparatus of claim 9, wherein one or more of the plurality of drive mode parameters is adjustable by the user.

11. The patient support apparatus of claim 9, wherein at least one of the plurality of drive mode parameters is defined based on an architectural layout associated with the location.

12. The patient support apparatus of claim 9, wherein at least one of the plurality of drive mode parameters is defined based on a driver training level associated with the location.

13. The patient support apparatus of claim 1, wherein the first user command is based on user engagement with the graphical user interface.

14. The patient support apparatus of claim 1, wherein the first user command is based on a recognized physical security token.

15. The patient support apparatus of claim 1, wherein the first user command is based on a recognized electronic security token.

16. A patient support apparatus comprising:
a support structure;
a support wheel coupled to the support structure;
a drive system including a drive member coupled to the support structure to influence motion of the patient support apparatus over a floor surface, a motor coupled to the drive member to operate the drive member at a speed, and a motor control circuit for transmitting power signals from a power source to the motor; and
a control system coupled to the drive system for operating the drive system, the control system including a memory device configured to store a plurality of drive profiles, and a controller coupled to the memory device and configured to:
detect a first drive profile based on at least one of a user input and a location associated with the patient support apparatus,
select the first drive profile from the plurality of stored drive profiles,
generate an output signal based on the selected first drive profile, and
transmit the generated output signal to the motor control circuit to operate the motor to operate the drive member in a first drive mode based on the selected first drive profile.

17. A patient support apparatus comprising:
a support structure;
a support wheel coupled to the support structure;
a drive system including a drive member coupled to the support structure to influence motion of the patient support apparatus over a floor surface, a motor coupled to the drive member to operate the drive member at a speed, and a motor control circuit for transmitting power signals from a power source to the motor; and
a control system coupled to the drive system for operating the drive system, the control system including a memory device configured to store a plurality of drive profiles, and a controller coupled to the memory device and configured to:
detect a first location of the patient support apparatus,
select a first drive profile from the plurality of stored drive profiles based on the location of the patient support apparatus,
generate an output signal based on the selected first drive profile, and
transmit the generated output signal to the motor control circuit to operate the motor to operate the drive member in a first drive mode based on the selected first drive profile.

18. The patient support apparatus of claim 17, wherein the controller is further configured to:
detect a second location associated with the patient support apparatus,
select a second drive profile from the plurality of stored drive profiles based on the second location;
generate an output signal based on the selected second drive profile; and
transmit the generated output signal to the motor control circuit to operate the motor to operate the drive member in a second drive mode based on the selected second drive profile.

19. The patient support apparatus of claim 18, wherein:
the first drive mode includes a first drive mode parameter,
the second drive mode includes a second drive mode parameter, and
the first drive mode parameter is different from the second drive mode parameter.

20. The patient support apparatus of claim 19, wherein the first drive mode parameter and the second drive mode parameter include one of: a rotational speed of the drive member, an acceleration rate of the drive member, a deceleration rate of the drive member, and a power setting.

21. (canceled)
